(19) United States
(12) Patent Application Publication
(10) Pub. No.: US 2024/0007847 A1
(43) Pub. Date: Jan. 4, 2024

(54) eSIM PROFILE MANAGEMENT FOR WIRELESS DEVICES

(71) Applicant: Apple Inc., Cupertino, CA (US)

(72) Inventors: Raj S. CHAUGULE, Santa Clara, CA (US); He ZHENG, Irvine, CA (US); Li LI, Los Altos, CA (US); Suraj GUPTA, Santa Clara, CA (US)

(21) Appl. No.: 18/327,005

(22) Filed: May 31, 2023

Related U.S. Application Data
(60) Provisional application No. 63/367,594, filed on Jul. 1, 2022.

(51) Int. Cl. H04W 8/26; H04W 8/18; H04L 67/55

(52) U.S. Cl. CPC H04W 8/265; H04W 8/183; H04L 67/55

(57) ABSTRACT

This Application sets forth techniques for managing electronic subscriber identity module (eSIM) profiles at a wireless device, including accommodating delays and/or error conditions that can occur during provisioning, installation, and/or activation of an eSIM for the wireless device. A wireless device implements one or more monitoring modes to determine changes in status of a newly installed eSIM, a re-activated eSIM, and/or a replenished data eSIM, and learn when the eSIM can be used to access services of a cellular wireless network. The wireless device can detect eSIM status changes based on messages received from a cellular wireless network or by testing data connections to a pre-configured test connectivity end point.

### CROSS-REFERENCE TO RELATED APPLICATIONS

The present application claims the benefit of U.S. Provisional Application No. 63/367,594, entitled “eSIM PROFILE MANAGEMENT FOR WIRELESS DEVICES,” filed Jul. 1, 2022, the content of which is incorporated by reference herein in its entirety for all purposes.

### FIELD

The described embodiments set forth techniques for managing provisioning and monitoring status of an electronic subscriber identity module (eSIM) profile for a wireless device, including, in some cases, transfer of a cellular wireless service plan associated with a subscriber identity module (SIM) or eSIM between wireless devices.

### BACKGROUND

Many wireless devices are configured to use removable Universal Integrated Circuit Cards (UICCs) that enable the wireless devices to access services provided by Mobile Network Operators (MNOs). In particular, each UICC includes at least a microprocessor and a read-only memory (ROM), where the ROM is configured to store an MNO profile that the wireless device can use to register and interact with an MNO to obtain wireless services via a cellular wireless network. A profile may also be referred to as subscriber identity module (SIM). Typically, a UICC takes the form of a small removable card, commonly referred to as a SIM card, which is inserted into a UICC-receiving bay of a mobile wireless device. In more recent implementations, UICCs are being embedded directly into system boards of wireless devices as embedded UICCs (eUICCs), which can provide advantages over traditional, removable UICCs. The eUICCs can include a rewritable memory that can facilitate installation, modification, and/or deletion of one or more electronic SIMs (eSIMs) on the eUICC, where the eSIMs can provide for new and/or different services and/or updates for accessing extended features provided by MNOs. An eUICC can store a number of MNO profiles—also referred to herein as eSIMs—and can eliminate the need to include UICC-receiving bays in wireless devices.

Provisioning an eSIM to a wireless device includes multiple stages to complete, including at the wireless device on which the eSIM is installed, at manufacturer servers that manage the wireless device, and at MNO servers from which the eSIM is downloaded and activated for service. Communication and/or processing delays among different entities involved in provisioning can result in various error conditions occurring. The wireless device can attempt to download or use an eSIM before associated MNO servers are ready to provide the eSIM or to allow cellular wireless service associated the eSIM, which can result in a poor user experience with installation and activation of cellular wireless service. In addition, some wireless devices can include data-only eSIMs with usage limits and can benefit from monitoring status of the data-only eSIM to improve user experience. There exists a need for mechanisms to manage eSIM profile provisioning and status monitoring for wireless devices to account for delays and/or error conditions.

### SUMMARY

This Application sets forth techniques for managing electronic subscriber identity module (eSIM) profiles for a wireless device, including accommodating delays and/or error conditions that can occur during provisioning, installation, activation, and/or re-activation of an eSIM profile for the wireless device. Multiple network-based servers of a mobile network operator (MNO) (and in some cases of a manufacturer of the wireless device) are involved in provisioning and activation (or re-activation) of an eSIM profile. Delays can occur between i) receipt of information specifying assignment of an eSIM profile to the wireless device, ii) availability of the eSIM profile for downloading from an MNO provisioning server, e.g., a subscription manager data preparation (SM-DP+) server, and iii) activation (or re-activation) of a cellular wireless service plan for the eSIM profile on MNO back-end systems, e.g., at a home subscriber server (HSS), allowing access to cellular wireless service based on credentials included in the eSIM profile. Additionally, notification messages prompting the wireless device regarding eSIM profile status from a manufacturer-managed, network-based server can be delayed, lost, or unavailable (due to limited data connectivity of the wireless device).

A wireless device implements one or more monitoring modes to determine availability of and/or changes in status to an eSIM profile. In a delayed eSIM provisioning monitor mode, the wireless device polls an MNO provisioning server, e.g., the SM-DP+ server, and/or polls a manufacturer-managed discovery server that assists the MNO provisioning server, to ascertain availability of an eSIM profile, previously assigned to the wireless device, for downloading and installing on an embedded universal integrated circuit card (eUICC) of the wireless device. An MNO entitlement server can indicate to the wireless device whether the eSIM profile is currently available or may incur a delay before being available to download to the wireless device. In some embodiments, the wireless device can download the eSIM profile responsive to receipt of a push notification message received from a manufacturer-managed, network-based server. The delayed eSIM provisioning monitor mode can operate as a background process to allow for recovery from an error condition that occurs during a wireless device initialization or configuration procedure that includes installation of the eSIM profile. The delayed eSIM provisioning monitor mode can complete when the eSIM profile is successfully installed or after a threshold number of retry attempts has been reached.

A wireless device can also implement an eSIM activation monitor mode to determine when a newly installed eSIM, a re-activated eSIM, and/or a replenished data eSIM can be used to access services of a cellular wireless network. In some embodiments, the wireless device determines one or more network conditions to monitor to determine when the cellular wireless network has completed activation, re-activation, or data replenishment of the eSIM profile. The wireless device can refrain from indicating an eSIM profile is active, e.g., in user-accessible cellular settings, until the one or more network conditions regarding a network-activated eSIM profile are satisfied. In some embodiments, the wireless device implements a network attach monitor mode and blocks attempts to use an eSIM profile, e.g., to establish an Internet packet data protocol (PDP) context, until after receiving an attach success message from a cellular wireless network of an MNO associated with the eSIM profile. In some embodiments, the wireless device implements an entitlement server monitor mode using an established (or re-established) Internet PDP context and marks the eSIM profile as active after receiving a response from an MNO entitlement server indicating a cellular wireless service account subscription status for the eSIM profile is activated. In some embodiments, the wireless device sends queries to the MNO entitlement server via a dedicated access point name (APN), when the MNO associated with the eSIM profile disallows Internet data connectivity prior to activation of the eSIM profile by the MNO's core cellular wireless network. In some embodiments, the wireless device implements a hypertext transfer protocol (HTTP) redirect monitor mode that monitors when a socket connection can be successfully established and data received from a pre-configured connectivity test end point. The wireless device can mark an eSIM profile as active after receiving a successful read response via a socket connection established with the pre-configured connectivity test end point. The wireless device can determine which of the monitor modes to use for a particular eSIM profile based on the MNO associated with the particular eSIM profile.

In some embodiments, a source wireless device transfers a cellular wireless service plan associated with an eSIM profile from the source wireless device to a new eSIM profile downloaded to a target wireless device. The source wireless device can implement an eSIM deactivation monitor mode to determine when the eSIM profile on the source wireless device is no longer active and/or when the new eSIM profile on the target wireless device is active. The source wireless device can receive from the target wireless device, via a cloud network-based service, a message that includes an identifier for the new eSIM profile installed on the target wireless device. The source wireless device can attempt to authenticate with and attach to a cellular wireless network of an MNO using credentials of the transferred eSIM profile. The source wireless device can determine that the eSIM profile is inactive after receiving i) a network attach reject message from the MNO's cellular wireless network and/or ii) a response from an entitlement server of the MNO indicating an authentication failure. The source wireless device can then mark the eSIM profile as transferred and inactive on the source wireless device.

Other aspects and advantages of the invention will become apparent from the following detailed description taken in conjunction with the accompanying drawings which illustrate, by way of example, the principles of the described embodiments.

This Summary is provided merely for purposes of summarizing some example embodiments so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

The disclosure will be readily understood by the following detailed description in conjunction with the accompanying drawings, wherein like reference numerals designate like structural elements.

FIG. 1 illustrates a block diagram of different components of an exemplary system configured to implement the various techniques described herein, according to some embodiments.

FIG. 2 illustrates a block diagram of a more detailed view of exemplary components of the system of FIG. 1, according to some embodiments.

FIG. 3A illustrates a flow diagram of exemplary stages for provisioning eSIM profiles to wireless devices, according to some embodiments.

FIG. 3B illustrates exemplary user interface (UI) screens for provisioning an eSIM profile at a wireless device, according to some embodiments.

FIG. 4 illustrates a flowchart of an example of MNO dependent delay during provisioning, installation, and activation of an eSIM profile on a wireless device, according to some embodiments.

FIG. 5 illustrates a block diagram of exemplary delays and communication issues for provisioning and installation of an eSIM profile to a wireless device, according to some embodiments.

FIG. 6A illustrates a flowchart of an exemplary monitor mode implemented by a wireless device to accommodate delays during provisioning of an eSIM profile, according to some embodiments.

FIG. 6B illustrates a diagram of an exemplary set of actions implemented at a wireless device for an eSIM provisioning monitor mode, according to some embodiments.

FIG. 6C illustrates a flowchart of an exemplary eSIM provisioning monitor mode method implemented at a wireless device for eSIM provisioning and installation, according to some embodiments.

FIG. 7 illustrates a diagram of an example of an MNO delay in provisioning an eSIM profile to a wireless device, according to some embodiments.

FIG. 8 illustrates a diagram of an example of monitoring at a source wireless device for deactivation of an eSIM profile after transfer of a cellular wireless service to a target wireless device, according to some embodiments.

FIGS. 9A and 9B illustrate diagrams of an exemplary network attach monitor mode implemented at a wireless device to detect eSIM activation of an eSIM profile, according to some embodiments.

FIGS. 10A and 10B illustrate diagrams of an exemplary entitlement monitor mode implemented at a wireless device to detect eSIM activation of an eSIM profile, according to some embodiments.

FIGS. 11A and 11B illustrate diagrams of an exemplary HTTP redirect monitor mode implemented at a wireless device to detect eSIM activation of an eSIM profile, according to some embodiments.

FIG. 11C illustrates a flowchart of exemplary triggers to cause a wireless device to perform an HTTP redirect probe to detect eSIM activation of an eSIM profile, according to some embodiments.

FIG. 12 illustrates a block diagram of exemplary elements of a mobile wireless device, according to some embodiments.

### DETAILED DESCRIPTION

Representative applications of methods and apparatus according to the present application are described in this section. These examples are being provided solely to add context and aid in the understanding of the described embodiments. It will thus be apparent to one skilled in the art that the described embodiments may be practiced without some or all of these specific details. In other instances, well known process steps have not been described in detail in order to avoid unnecessarily obscuring the described embodiments. Other applications are possible, such that the following examples should not be taken as limiting.

In the following detailed description, references are made to the accompanying drawings, which form a part of the description and in which are shown, by way of illustration, specific embodiments in accordance with the described embodiments. Although these embodiments are described in sufficient detail to enable one skilled in the art to practice the described embodiments, it is understood that these examples are not limiting; such that other embodiments may be used, and changes may be made without departing from the spirit and scope of the described embodiments.

This Application sets forth techniques for managing electronic subscriber identity module (eSIM) profile provisioning to a wireless device, including accommodating delays and/or error conditions that can occur during provisioning, installation, activation, and/or de-activation of an eSIM on the wireless device. Multiple network-based servers of a mobile network operator (MNO), and in some cases one or more servers managed by a manufacturer of the wireless device, are involved in provisioning and an eSIM profile to a wireless device to provide access to cellular wireless services of the MNO. Delays and/or error conditions can occur during one or more phases of provisioning and enabling the eSIM profile for service. The wireless device can receive from an MNO entitlement server information specifying assignment of an eSIM profile to the wireless device before the eSIM profile is available for downloading from a separate MNO provisioning server, e.g., a subscription manager data preparation (SM-DP+) server. A push notification message from a manufacturer-managed, network-based server indicating availability of the eSIM profile for download can be lost in transmission or undeliverable to the wireless device, when data connectivity to receive the push notification message is not available. After the wireless device downloads and installs the eSIM profile on an embedded integrated circuit card (eUICC) of the wireless device, the eSIM profile may not yet be activated on MNO back-end systems, e.g., at a home subscriber server (HSS), to allow access to cellular wireless service based on credentials included in the eSIM profile. Transfer of a wireless cellular service plan associated with an eSIM profile on a source wireless device to a target wireless device includes provisioning, downloading, installing, and activating a new eSIM profile on the target wireless device, and de-activating the old eSIM profile on the source wireless device. The source wireless device needs to determine when the new eSIM profile is activated and the old eSIM profile is de-activated from the point of view of the servers of the MNO associated with eSIM profiles. To reduce wait times incurred by delays or error conditions associated with eSIM provisioning, activation, and de-activation processes, a wireless device can monitor various cellular wireless network responses to determine status of an eSIM profile for download, installation, activation, and/or de-activation.

A wireless device can implement one or more monitoring modes to determine the availability of an eSIM profile for downloading and/or activation status changes of an eSIM profile at one or more MNO servers. The wireless device can use information obtained directly from cellular wireless network messages or gleaned indirectly from network responses to various queries to determine status of an eSIM profile. Provisioning an eSIM profile to a wireless device involves multiple phases including: i) a pre-installation phase for authentication of the wireless device with an MNO entitlement server, ii) an installation phase for downloading an eSIM profile from a provisioning server and installing the eSIM profile on an eUICC of the wireless device, iii) and a post-installation phase for enabling the eSIM profile at the wireless device and activation of the eSIM profile within an MNO cellular wireless network. The wireless device can access services of an MNO's cellular wireless network after all phases are completed. Monitoring modes can be used by the wireless device to accommodate delays or error conditions that occur in one or more phases.

In a delayed eSIM provisioning monitor mode, the wireless device polls an MNO provisioning server, e.g., the SM-DP+ server, and/or polls a manufacturer-managed discovery server that assists the MNO provisioning server, to determine availability of an eSIM profile, previously assigned to the wireless device, for downloading to and installing on an embedded universal integrated circuit card (eUICC) of the wireless device. During a pre-installation phase, the wireless device receives, from an MNO entitlement server, a message that identifies the eSIM profile and, in some embodiments, indicates whether the eSIM profile is currently available for downloading and installation. In some embodiments, the MNO entitlement server provides an indication of a delay until installation of the eSIM profile is available. In some embodiments, the delay is indeterminate, and the wireless device determines when to download the eSIM profile. In some embodiments, the wireless device downloads the eSIM profile responsive to receipt of a push notification message from a manufacturer-managed, network-based message notification server. In some embodiments, the wireless device has limited or no data connectivity to receive the push notification message, e.g., no Wi-Fi connection available or limited access via a bootstrap provisioning eSIM profile without data connectivity for the push notification messaging. In some embodiments, the wireless device can use the bootstrap provisioning eSIM profile to communicate with the MNO entitlement server, with the MNO provisioning server, or with a manufacturer-managed discovery server, but not with the manufacturer-managed message notification server. The wireless device can poll the MNO provisioning server or the manufacturer-managed discovery server to determine availability of the eSIM profile for downloading to the wireless device. In some embodiments, the wireless device monitors responses from polling in parallel monitoring for a pushing notification message, using either mechanism to determine when an eSIM profile is available for download from the MNO provisioning server. The delayed SIM provisioning monitor mode can operate as a background process to allow for recovery from an error condition during a wireless device initialization or configuration procedure that includes installation of the eSIM profile. The delayed eSIM provisioning monitor mode can end when the wireless device successfully downloads and installs the eSIM profile or after a threshold number of retry attempts has been reached.

In an eSIM activation monitor mode, the wireless device determines when a newly installed and activated eSIM profile, a re-activated eSIM profile, and/or a replenished data eSIM profile can be used to access services provided by a cellular wireless network of an MNO associated with the eSIM profile. In some embodiments, the wireless device determines one or more network conditions to monitor to learn when the cellular wireless network has completed activation of the eSIM profile. The wireless device can refrain from indicating an eSIM is active, e.g., in user-accessible cellular settings, until the one or more network conditions are satisfied. Different network conditions can be monitored as part of the eSIM activation monitor mode, including non-access stratum (NAS) network attach responses, entitlement server account query responses, and Internet data connectivity test responses. In some embodiments, the wireless device implements a network attach monitor mode and blocks attempts to establish an Internet packet data protocol (PDP) context until after receiving a network attach success message from a cellular wireless network of an MNO associated with the eSIM profile. In some embodiments, the wireless device implements an entitlement server monitor mode using an established (or re-established) Internet PDP context and marks the eSIM profile as active after receiving a response from an MNO entitlement server that indicates the eSIM profile is active. For example, the MNO entitlement server can respond to a cellular wireless service account subscription status query and provide the eSIM profile status. In some embodiments, account subscription status queries are sent to a dedicated access point name (APN) when the MNO associated with the eSIM profile disallows Internet data connectivity prior to activation of the eSIM profile. In some embodiments, the wireless device implements a hypertext transfer protocol (HTTP) redirect-based monitor mode that monitors when a socket connection can be successfully established to and data received from a pre-configured connectivity test end point. The wireless device can mark an eSIM profile as active after receiving a successful read response via a socket connection established with the pre-configured connectivity test end point. The wireless device can determine which of the multiple network monitor modes to use for a particular eSIM profile based on the MNO associated with the particular eSIM profile. In some embodiments, an MNO specifies the wireless device to use a particular network monitor mode, e.g., an HTTP redirect-based monitor mode, via a protocol configuration options (PCO) message.

In some embodiments, a source wireless device transfers a cellular wireless service plan associated with an eSIM profile from the source wireless device to a new eSIM profile downloaded to a target wireless device. The source wireless device can implement an eSIM deactivation monitor mode to determine when the eSIM profile on the source wireless device is no longer active and/or when the new eSIM profile on the target wireless device is active. The source wireless device can receive from the target wireless device, via a cloud network service to which both the source wireless device and the target wireless device belong, a message that includes an identifier for the new eSIM profile installed on the target wireless device. The source wireless device can attempt to authenticate with and attach to a cellular wireless network of the MNO using credentials of the old eSIM profile. The source wireless device can determine that the old eSIM profile is inactive after receiving i) a network attach reject message from the MNO's cellular wireless network and ii) a message from the MNO entitlement server indicating an authentication failure. The source wireless device can then mark the old eSIM profile as transferred and inactivated on the source wireless device, e.g., in a user-accessible cellular settings.

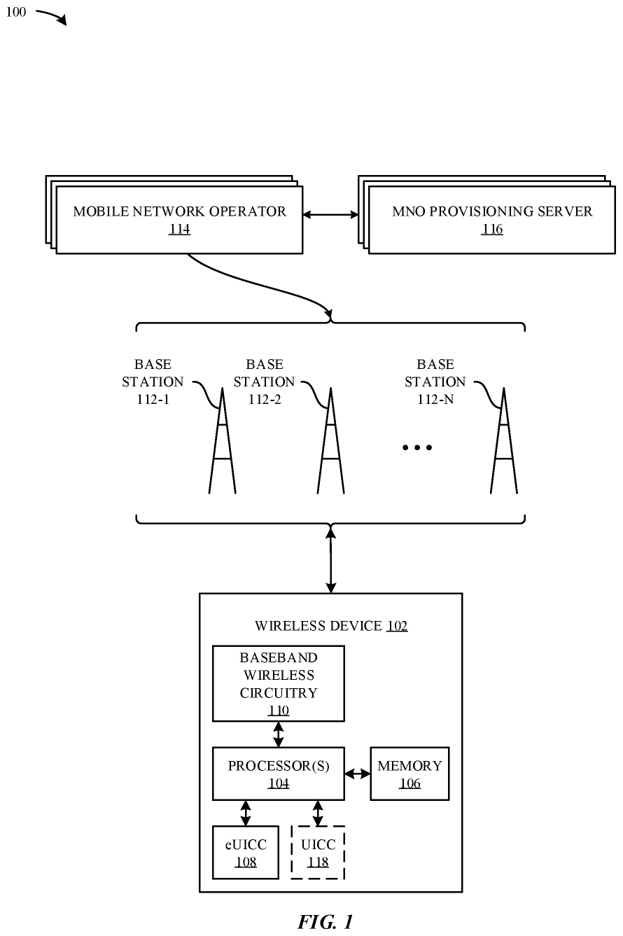

These and other embodiments are discussed below with reference to FIGS. 1-12; however, those skilled in the art will readily appreciate that the detailed description given herein with respect to these figures is for explanatory purposes only and should not be construed as limiting.

FIG. 1 illustrates a block diagram of different components of a system 100 that is configured to implement the various techniques described herein, according to some embodiments. More specifically, FIG. 1 illustrates a high-level overview of the system 100, which, as shown, includes a wireless device 102, which can also be referred to as a device, a wireless device, a mobile device, a user equipment (UE) and the like, a group of base stations 112-1 to 112-N that are managed by different Mobile Network Operators (MNOs) 114, and a set of provisioning servers 116 that are in communication with the MNOs 114. Additional MNO infrastructure servers, such as used for account management and billing are not shown. The wireless device 102 can represent a mobile computing device (e.g., an iPhone®, an iPad®, or an Apple Watch by Apple®), the base stations 112-1 to 112-n can represent cellular wireless network entities including evolved NodeBs (eNodeBs or eNBs) and/or next generation NodeBs (gNodeBs or gNB) that are configured to communicate with the wireless device 102, and the MNOs 114 can represent different wireless service providers that provide specific cellular wireless services (e.g., voice and data) to which the wireless device 102 can subscribe, such as via a subscription account for a user of the wireless device 102.

As shown in FIG. 1, the wireless device 102 can include processing circuitry, which can include one or more processor(s) 104 and a memory 106, an embedded Universal Integrated Circuit Card (eUICC) 108, and a baseband wireless circuitry 110 used for transmission and reception of cellular wireless radio frequency signals. The baseband wireless circuitry 110 can include analog hardware components, such as antennas and amplifiers, as well as digital processing components, such as signal processors (and/or general/limited purpose processors) and associated memory. In some embodiments, the wireless device 102 includes one or more physical UICCs 118, also referred to as Subscriber Identity Module (SIM) cards, in addition to or substituting for the eUICC 108. The components of the wireless device 102 work together to enable the wireless device 102 to provide useful features to a user of the wireless device 102, such as cellular wireless network access, non-cellular wireless network access, localized computing, location-based services, and Internet connectivity. The eUICC 108 can be configured to store multiple electronic SIMs (eSIMs) for accessing cellular wireless services provided by different MNOs 114 by connecting to their respective cellular wireless networks through base stations 112-1 to 112-N. For example, the eUICC 108 can be configured to store and manage one or more eSIMs for one or more MNOs 114 for different subscriptions to which the wireless device 102 is associated. To be able to access services provided by an MNO, an eSIM can be reserved for subsequent download and installation to the eUICC 108. In some embodiments, the eUICC 108 obtains one or more eSIMs from one or more associated MNO provisioning servers 116. The MNO provisioning servers 116 can be maintained by the MNOs 114, an OEM manufacturer, third party entities, and the like. Communication of eSIM data between an MNO provisioning server 116 and the eUICC 108 (or between the MNO provisioning server 116 and processing circuitry of the wireless device 102 external to the eUICC 108, e.g., the processor 104) can use a secure communication channel.

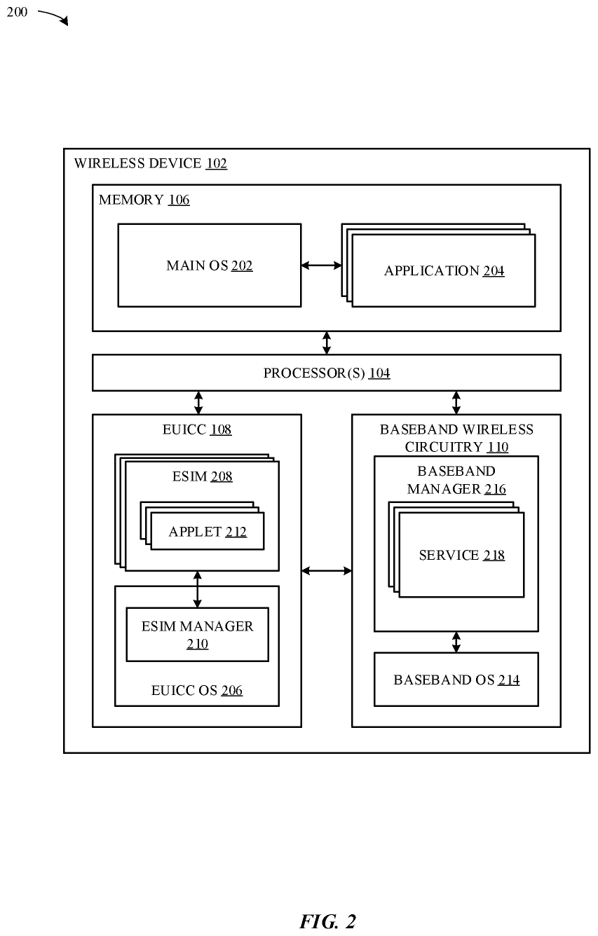

FIG. 2 illustrates a block diagram of a more detailed view 200 of particular components of the wireless device 102 of FIG. 1, according to some embodiments. As shown in FIG. 2, the processor(s) 104, in conjunction with memory 106, can implement a main operating system (OS) 202 that is configured to execute applications 204 (e.g., native OS applications and user applications). As also shown in FIG. 2, the eUICC 108 can be configured to implement an eUICC OS 206 that is configured to manage hardware resources of the eUICC 108 (e.g., a processor and a memory embedded in the eUICC 108). The eUICC OS 206 can also be configured to manage eSIMs 208 that are stored by the eUICC 108, e.g., by downloading, installing, deleting, enabling, disabling, modifying, or otherwise performing management of the eSIMs 208 within the eUICC 108 and to provide baseband wireless circuitry 110 with access to the eSIMs 208 to provide access to wireless services for the wireless device 102. The eUICC 108 OS can include an eSIM manager 210, which can perform management functions for various eSIMs 208. According to the illustration shown in FIG. 2, each eSIM 208 can include a number of applets 212 that define the manner in which the eSIM 208 operates. For example, one or more of the applets 212, when implemented in conjunction with baseband wireless circuitry 110 and the eUICC 108, can be configured to enable the wireless device 102 to communicate with an MNO 114 and provide useful features (e.g., phone calls and internet access) to a user of the wireless device 102.

As also shown in FIG. 2, the baseband wireless circuitry 110 of the wireless device 102 can include a baseband OS 214 that is configured to manage hardware resources of the baseband wireless circuitry 110 (e.g., a processor, a memory, different radio components, etc.). According to some embodiments, the baseband wireless circuitry 110 can implement a baseband manager 216 that is configured to interface with the eUICC 108 to establish a secure channel with an MNO provisioning server 116 and obtaining information (such as eSIM data) from the MNO provisioning server 116 for purposes of managing eSIMs 208. The baseband manager 216 can be configured to implement services 218, which represents a collection of software modules that are instantiated by way of the various applets 212 of enabled eSIMs 208 that are included in the eUICC 108. For example, services 218 can be configured to manage different connections between the wireless device 102 and MNOs 114 according to the different eSIMs 208 that are enabled within the eUICC 108.

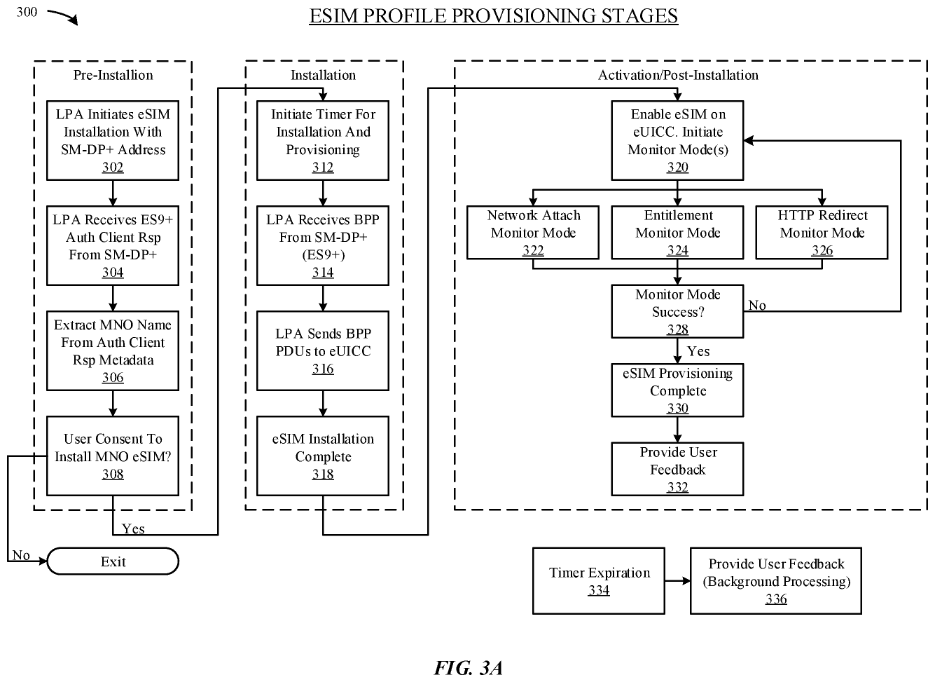

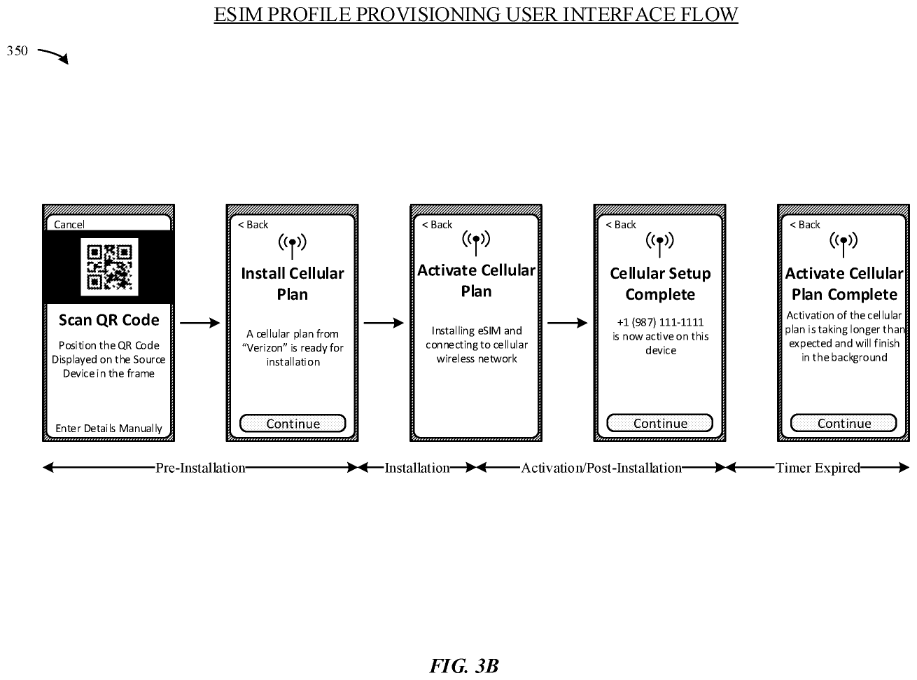

FIG. 3A illustrates a flow diagram 300 of exemplary stages to provision an eSIM 208 to a wireless device 102. In a pre-installation stage, at 302, a local profile assistant (LPA), executing on a processor external to an eUICC 108 of the wireless device 102, initiates the eSIM installation having received previously a network address, e.g., a universal resource locator (URL) or a fully qualified domain name (FQDN), for an MNO provisioning server, 116, e.g., an SM-DP+ server. At 304, the LPA receives an ES9+ authenticate client response message from the SM-DP+ server. At 306, the LPA extracts from the metadata of the authenticate client response message an identifier, e.g., a name, for the MNO 114 associated with the eSIM profile 208 to be downloaded and installed to the eUICC 108 of the wireless device 102. At 308, user consent is obtained, e.g., via a notification pop-up window on the wireless device 102, to install an eSIM profile 208 from the identified MNO 114. When user consent is denied or otherwise not obtained the eSIM installation process can end. When user consent is obtained, the wireless device 102 proceeds to an installation and activation stage. At 312, a watchdog timer is initiated to monitor time spent in the installation and provisioning process. At 314, the LPA downloads a bound profile package (BPP) that includes the eSIM profile 208 in an ES9+ message from the SM-DP+ server. At 316, the LPA transfers BPP protocol data units (PDUs), i.e., packets, of the BPP to the eUICC 108, which checks the BPP for integrity, extracts and installs the eSIM profile 208. At 318, installation of the eSIM profile 208 on the eUICC 108 of the wireless device 102 is complete. Upon completion of installation, the provisioning flow enters a post-installation stage, which includes activation of the eSIM profile 208 to be available to be used for access to services of the MNO's cellular wireless network. At 320, the eUICC enables the eSIM profile 208 and initiates one or more monitor modes to determine when the eSIM profile 208 has been activated by the MNO cellular wireless network. At 322, the wireless device 102 can use a network attach monitor mode to determine when the wireless device 102 can attach to a cellular wireless network of the MNO 114 using credentials of the eSIM profile 208 and subsequently register for service with the MNO cellular wireless network. At 324, the wireless device 102 can use an entitlement monitor mode to determine when the wireless device 102 receives, from an MNO entitlement server, a message indicating a cellular wireless service subscription associated with the eSIM profile 208 is activated. At 326, the wireless device 102 can use an HTTP redirect monitor mode to determine whether data can be successfully read via a socket connection to a pre-configured data test endpoint. At 328, the wireless device 102 can determine whether the eSIM profile 208 has been successfully activated within the MNO's cellular wireless network based on results from one or more of the monitor modes. In some embodiments, at least one or more monitor modes must provide a successful result for the wireless device 102 to determine the eSIM profile 208 is activated. In some embodiments, at least two or more monitor modes must provide successful results for the wireless device 102 to determine the eSIM profile 208 is activated. In some embodiments, the wireless device 102 uses (or requires successful results from) particular monitor modes for an MNO 114, as different monitor modes may be applicable (or most useful) to different MNO's cellular wireless networks. When the wireless device 102 determines that applicable monitor modes for the MNO 114 are not successful, the wireless device 102 can retry monitor modes again. In some embodiments, the wireless device 102 disables and re-enables the eSIM profile 208 before re-initiating the monitor modes. The wireless device 102 can continue to use the monitor modes to determine when the eSIM profile 208 is activated by the MNO 114. When the wireless device 102 determines, at 328, that the monitor modes applicable to the MNO 114 are successful, the wireless device 102, at 330, can determine that eSIM provisioning is completed. The wireless device 102, at 332, can provide user feedback, e.g., directly via a pop-up notification screen and/or indirectly within user-accessible cellular settings, that the eSIM profile 208 is activated and ready for use. In some embodiments, when the watchdog timer started at 312 expires, at 334, and installation or activation of the eSIM profile 208 has not completed, the wireless device 102, at 336, provides user feedback, e.g., directly via a pop-up notification screen and/or indirectly within user-accessible cellular settings, that installation and/or activation of the eSIM profile 208 has not completed and that the eSIM installation and activation monitoring will continue in the background, thereby allowing the user to continue to use the wireless device 102 for other non-cellular functions. In some embodiments, when multiple attempts to install or activate the eSIM profile 208 are not successful, the wireless device 102 can notify the user directly via a pop-up notification to contact the MNO 114 associated with the eSIM profile 208.

FIG. 3B illustrates a diagram 350 of exemplary user interface (UI) screens that can be presented during various stages of the eSIM profile provisioning process. During, the pre-installation stage, the wireless device 102 presents to the user options for obtaining an eSIM profile 208, such as via scanning a quick response (QR) code provided by an MNO 114 or from a source wireless device 102A from which to transfer a cellular wireless service plan. The wireless device 102 obtains consent from the user to install an eSIM profile 208 associated with a particular MNO 114, and then installs the eSIM profile 208 in the installation stage, which can complete when the eSIM profile 208 has been successfully downloaded from an MNO provisioning server 116, installed on an eUICC 108 of the wireless device 102, and subsequently enabled for use by the wireless device 102. Although the eSIM profile 208 can be enabled, the wireless device 102 can refrain from indicating that the eSIM profile 208 is ready to be used by the user of the wireless device 102 until activation of the eSIM profile 208 by the MNO 114 has completed and been detected by the wireless device 102 (such as using one or more monitoring modes). After successful activation of the eSIM profile 208, in the post-installation phase, the wireless device 102 can provide to the user a notification that cellular service is available using the eSIM profile 208. When activation of the eSIM profile 208 has not successfully completed within a threshold period of time, e.g., when a watchdog timer started in the installation stage expires, the wireless device 102 provides a notification to the user that activation will finish as a background process, to allow the user to continue using the wireless device 102 before the cellular wireless service is available via the eSIM profile 208.

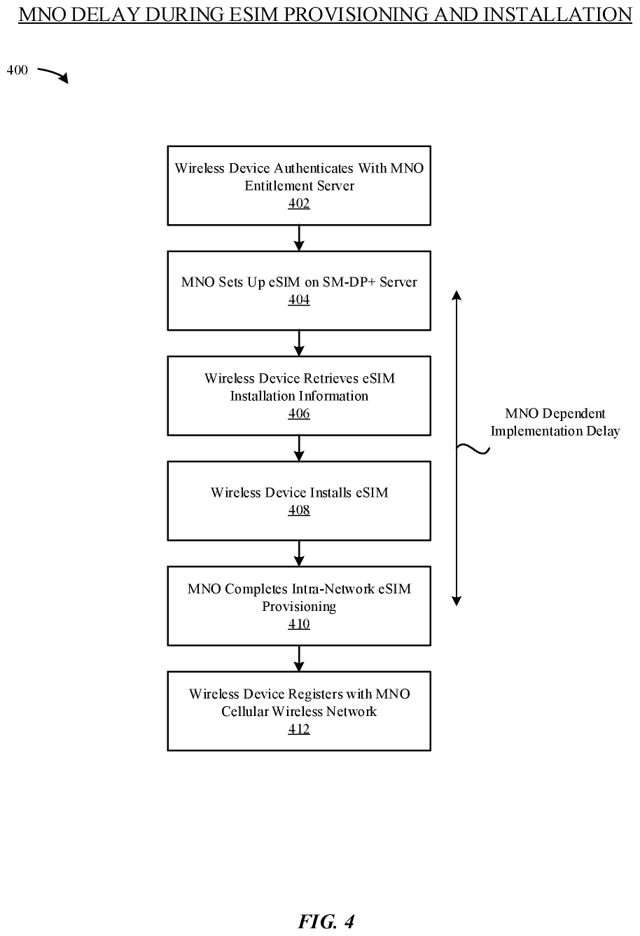

FIG. 4 illustrates a flowchart 400 of an example of MNO dependent delay that can occur during provisioning, installation, and activation of an eSIM profile 208 on a wireless device 102. At 402, the wireless device 102 authenticates with an MNO entitlement server. At 404, the MNO 114 sets up an eSIM profile 208 on a provisioning server 116, e.g., an SM-DP+ server, for downloading to the wireless device 102. At 406, the wireless device 102 retrieves eSIM installation information, e.g., a network address of the SM-DP+ server from which to obtain the eSIM profile 208. At 408, the wireless device 102 downloads the eSIM profile 208 from the SM-DP+ server and installs the eSIM profile 208 on an eUICC 108 of the wireless device 102. At 410, the MNO 114 associated with the eSIM profile 208 completes intra-network provisioning of the eSIM profile 208, e.g., on various back-end servers, such as a home subscriber server (HSS). At 412, the wireless device 102 successfully attaches to a cellular wireless network of the MNO 114 and subsequently registers for cellular wireless service access with the cellular wireless network of the MNO 114. Several delays can occur during the eSIM profile provisioning, installation, and activation process shown. In some cases, the wireless device 102 obtains information for the eSIM profile 208, e.g., an ICCID value, and a network address of the SM-DP+ server, before the eSIM profile 208 is available for download from the SM-DP+ server. Information for downloading the eSIM profile 208 can be provided by an MNO server (other than the SM-DP+ server) and/or by a manufacturer-managed server, e.g., a discovery server, before the eSIM profile 208 is actually available. In some embodiments, the eSIM profile 208 is available for download but not yet available to use for access to cellular wireless services of the MNO 114. Each MNO 114 uses their own implementation and maintenance schedule which can delay availability of the eSIM profile 208 for downloading and/or activation of the eSIM profile 208 within the MNO's core network. To reduce unnecessary, lengthy waiting periods for a user of the wireless device 102, and to reduce uncertainty of availability and/or status of an eSIM profile 208, the wireless device 102 can use various monitoring modes as discussed herein. In some cases, the wireless device 102 performs the monitoring modes as background processes after a timeout period to allow use of the wireless device 102 for other (non-cellular) purposes.

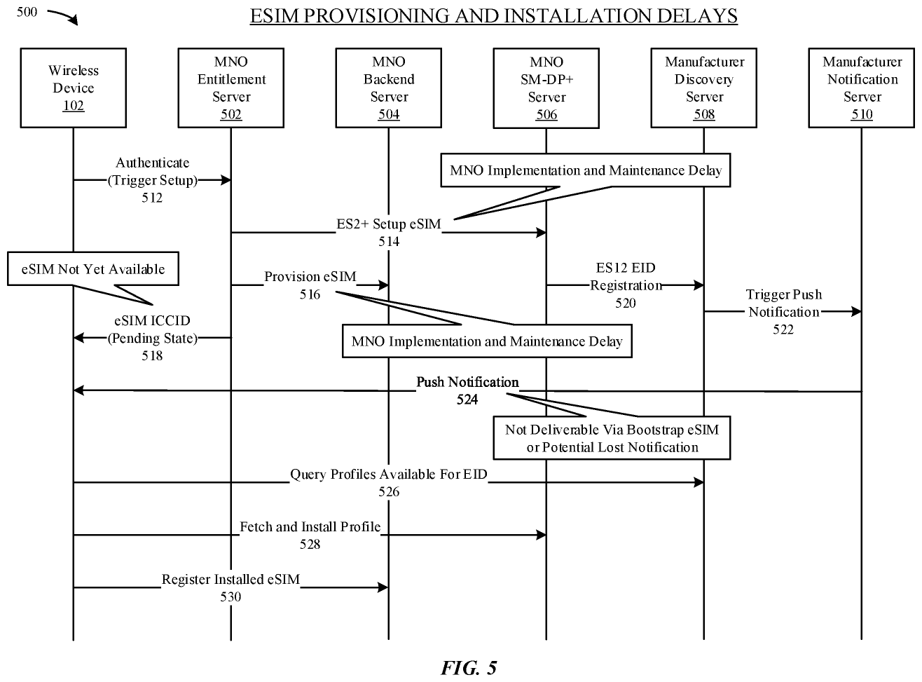

FIG. 5 illustrates a block diagram 500 of exemplary delays and communication issues that can occur during an eSIM profile provisioning, installation, and activation process. Communication between the wireless device 102 and various MNO and manufacturer network-based servers can use a non-cellular wireless connection, a cellular wireless connection via a SIM or eSIM profile 208 (i.e., other than the eSIM profile being provisioned), or via a limited functionality, bootstrap eSIM 208. When using the limited functionality, bootstrap eSIM 208, only certain servers can communicate with the wireless device 102. For example, the MNO entitlement server 502, the MNO SM-DP+ server 506, and the manufacturer discovery server may be reachable by the wireless device 102, but the manufacturer notification server 510 may be unable to communicate with the wireless device 102 via the bootstrap eSIM 208. At 512, the wireless device 102 authenticates with an MNO entitlement server 502 to trigger setup of an eSIM profile 208. In some embodiments, the authentication message sent by the wireless device 102 is associated with transfer of a cellular wireless plan, e.g., from a source wireless device 102A to the wireless device 102 as a target wireless device 102B. In some embodiments, the authentication message sent by the wireless device 102 includes a transfer token indicating authority to obtain an eSIM profile 208 associated with transfer of a cellular wireless service plan. At 514, the MNO entitlement server 502 sends an ES2+ message to an MNO SM-DP+ server 506 to setup an eSIM profile 208. Setup of the eSIM profile 208 on the SM-DP+ server 506 is required before the wireless device 102 can download and install the eSIM profile 208. Setup of the eSIM profile 208 can be delayed due to MNO implementation processes and/or due to MNO maintenance issues. The amount of delay incurred can vary for different MNOs 114 and depend on MNO planning, e.g., time-of-day, day-of-week dependencies. As such the wireless device 102 cannot know, a priori, how long it will take the MNO 114 to complete the eSIM setup procedure. At 516, the MNO entitlement server 502 sends a message to an MNO backend server 504 to provision the eSIM profile for cellular wireless service. Again, there can be a delay for this provisioning to occur at the MNO backend server 504. At 518, the MNO entitlement server 502 responds to the wireless device 102 with a message that includes a unique identifier for the eSIM profile 208 to be downloaded, e.g., an ICCID value of the eSIM profile 208. The message can also include an indication that the eSIM profile 208 is pending release and not yet available for downloading by the wireless device 102. Due to indeterminate delays, the wireless device 102 can attempt to contact a manufacturer discovery server 508 for information regarding the eSIM profile 208 or attempt to download the eSIM profile 208 from the SM-DP+ server 506 before the eSIM profile 208 is available for downloading. To avoid these issues, the wireless device 102 can await a push notification message indicating availability of the eSIM profile 208 for downloading. In some embodiments, the MNO SM-DP+ server 506, at 520, sends, to a manufacturer-managed discovery server 508, an ES12 registration message that includes a unique identifier associated with the wireless device 102, e.g., an eUICC identifier (EID) value of the eUICC 108 on which the eSIM profile 208 is to be downloaded and installed. The ES12 registration message can be sent when the eSIM profile 208 is available for download to the wireless device 102. The manufacturer discovery server 508, at 522, can send a message to a manufacturer notification server 510 to trigger a push notification message sent to the wireless device 102, at 524, to indicate that the eSIM profile 208 is available to download from the MNO's SM-DP+ server 506. In some cases, the push notification may not reach the wireless device 102, as the push notification message can be lost in transmission or can be undeliverable to the wireless device 102. In some cases, the wireless device 102 lacks a non-cellular data connection (or a full functionality cellular data connection) by which to receive the push notification message. The wireless device may be using a limited functionality, bootstrap provisioning eSIM profile 208 with restricted cellular wireless access before obtaining the fully functional eSIM profile 208 and is not able to receive the push notification message via the bootstrap eSIM profile's limited functionality cellular wireless connection. At 526, the wireless device 102 queries the manufacturer discovery server for the availability of eSIM profiles 208 marked for the eUICC 108 having a particular EID value. In some cases, the wireless device 102 sends the query responsive to the push notification message. In some cases, the wireless device 102 polls the manufacturer discover server in the absence of receipt of a push notification message. Proactive polling by the wireless device 102 can reduce a delay between availability of the eSIM profile 208 on the MNO SM-DP+ server 506 and delivery of the push notification message to the wireless device 102. At 528, the wireless device 102 downloads and installs the eSIM profile 208 from the SM-DP+ message. At 530, the wireless device 102 registers the downloaded and installed eSIM profile 208 with an MNO backend server, e.g., an HSS server, for access to cellular wireless services of the MNO.

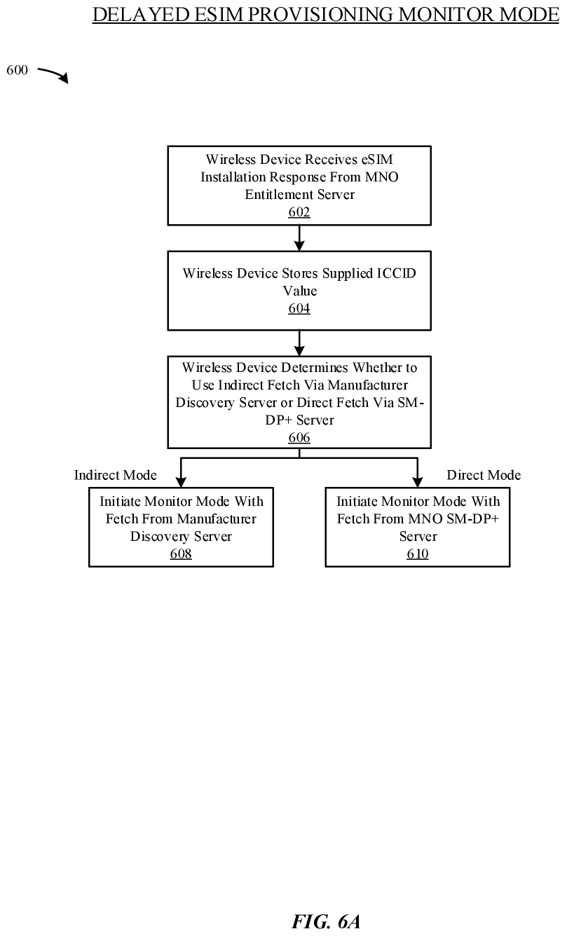

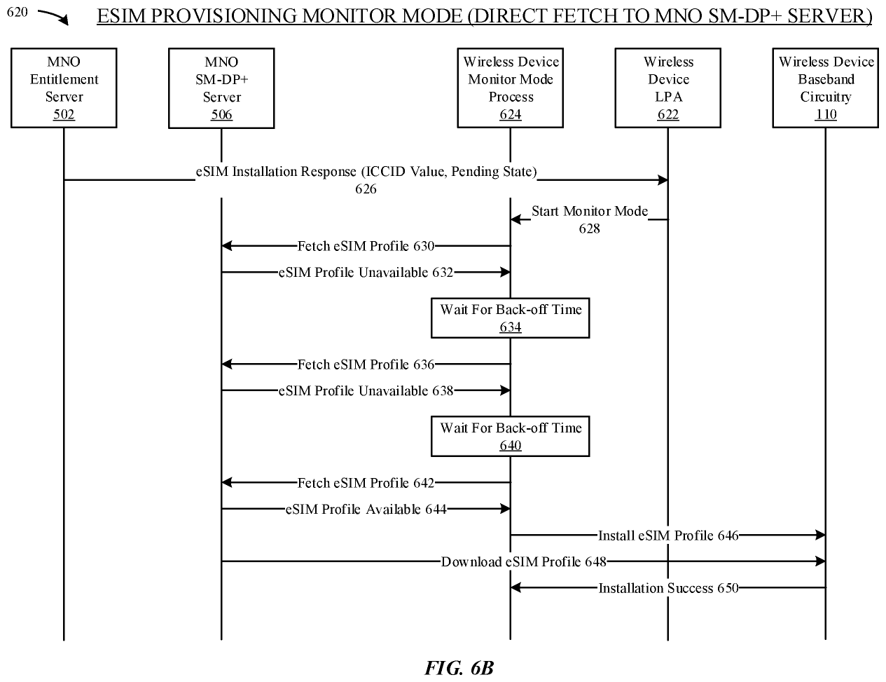

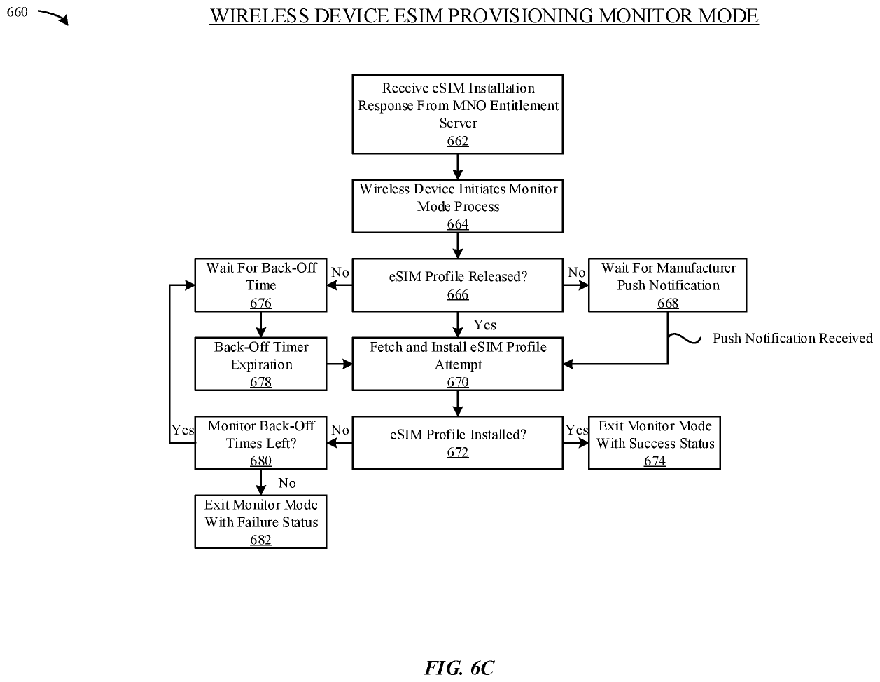

FIG. 6A illustrates a flowchart 600 of an exemplary delayed eSIM provisioning monitor mode implemented by a wireless device 102 to accommodate one or more delays during provisioning of an eSIM profile 208 to the wireless device 102. The delayed eSIM provisioning monitor mode can be used to allow the wireless device 102 to discover availability and download the eSIM profile 208 without having an available cellular data plan (before installation of the eSIM profile 208) or non-cellular wireless access. The monitor mode can also be restarted after failure of an eSIM profile 208 installation. At 602, the wireless device 102 receives, from an MNO entitlement server 502, an eSIM installation response that includes a unique identifier, e.g., an ICCID value, for the eSIM profile 208 to be installed on the eUICC 108 of the wireless device 102. At 604, the wireless device 102 stores the provided ICCID value. At 606, the wireless device 102 determines whether to use i) an indirect mode with queries sent to a manufacturer discovery server 508, which can provide information regarding availability of one or more eSIM profiles 208 for the wireless device 102 and one or more network addresses for MNO provisioning servers 116, e.g., MNO SM-DP+ servers 506, from which to download the one or more eSIM profiles 208, or ii) a direct mode with queries sent to the MNO SM-DP+ servers 506. In some embodiments, the eSIM installation response from the MNO entitlement server 502 indicates whether the wireless device 102 should use the indirect mode querying the manufacturer discovery server 508 or the direct mode querying the MNO SM-DP+ server 506. When using the indirect mode, the wireless device 102 polls the manufacturer discovery server 508 to determine availability of the eSIM profile 208 for download from an MNO SM-DP+ server 506. The manufacturer discovery server 508 can provide a network address, e.g., URL value or FQDN value, for the MNO SM-DP+ server in response to the query from the wireless device 102 when the eSIM profile 208 is available for downloading. When using the direct mode, the wireless device 102 polls the MNO SM-DP+ server 506 directly to determine availability of the eSIM Profile 208 for downloading to the wireless device 102.

The wireless device 102 can use the polling mechanism of the delayed eSIM provisioning monitor mode to check for availability of the eSIM profile 208 on the MNO SM-DP+ server 506 without relying on a push notification message from the manufacturer notification server 510. Polling intervals can be tailored to each individual MNO 114 and can account for processing delays, maintenance schedules, and/or dynamic loading of MNO network servers to reduce delay (when an eSIM profile 208 is available but not retrieved) and to limit extra queries (when an eSIM profile 208 is not yet available to be retrieved). In some embodiments, the eSIM installation response from the MNO entitlement server 502 received at 602 can include an indication of whether the eSIM profile 208 is currently available for downloading from the MNO SM-DP+ server 506 or requires the wireless device 102 to wait to download the eSIM profile 208. In some embodiments, a back-off timer is initiated for the delayed eSIM provisioning monitor mode, and polling begins after expiration of the back-off timer. In some embodiments, the back-off timer can be restarted after each expiration up to a back-off timer threshold number of times.

FIG. 6B illustrates a diagram 620 of an exemplary set of actions implemented at a wireless device 102 for an eSIM provisioning monitor mode with regular polling of an MNO SM-DP+ server 506. Intervals between polling can be tailored to each MNO 114, such as specified in carrier bundle settings, can be based on a parameter specified by the MNO 114, or can be based on dynamic network conditions of the cellular wireless network of the MNO 114. At 626, a local profile assistant (LPA) 622, executing on a processor external to an eUICC 108 of the wireless device 102, receives from an MNO entitlement server 502 an eSIM installation response message that includes a unique identifier, e.g., an ICCID value, for the eSIM profile 208 to be installed and (in some embodiments) a pending state indicating whether the eSIM profile 208 is available for downloading at that time or requires the wireless device 102 to wait for a period of time. The wireless device 102 uses the ICCID value of the eSIM 208 to identify to the MNO SM-DP+ server 506 a specific eSIM profile 208 to download to the wireless device 102. When the eSIM profile 208 is available at that time, the wireless device 102 can instruct the baseband wireless circuitry 110 of the wireless device 102 to download and install the eSIM profile 208 from an applicable MNO provisioning server 116, e.g., the SM-DP+ server 506. When the eSIM profile 208 is not currently available to download, the LPA 622, at 628, initiates a wireless device monitor mode process 624 for eSIM provisioning, where the wireless device monitor mode process 624 is also executing on the processor of the wireless device 102 external to the eUICC 108. In some embodiments, upon starting the monitor mode, the wireless device monitor mode process 624 initiates a back-off timer, waits for the back-off timer to expire, and then polls the MNO SM-DP+ server 506 for availability of the eSIM profile 208. In some embodiments, the wireless device monitor mode process 624 attempts to fetch the eSIM profile 208 from the MNO SM-DP+ server 626 immediately (or soon) after starting. At 630, the wireless device monitor mode process 624 sends a fetch message to the MNO SM-DP+ server 506 to retrieve the eSIM profile 208. At 632, the MNO SM-DP+ server 506 returns to the wireless device LPA 622, a response message indicating that the eSIM profile 208 identified in the fetch message is not yet available for downloading. The wireless device monitor mode process 624, at 634, waits for the back-off timer to expire, and then retries polling the MNO SM-DP+ server at 636, which again replies with an eSIM profile unavailable message at 638. The wireless device monitor mode process 624, at 640, again waits for the back-off timer to expire, and then again, at 642, retries polling the MNO SM-DP+ server, which replies, at 644, with a message indicating availability of the eSIM profile 208 for downloading to the wireless device 102. Responsive to the positive indication from the MNO SM-DP+ server 506 indicating availability of the eSIM profile 208, the wireless device monitor mode process 624 sends a command, at 646, to the baseband wireless circuitry 110 to install the eSIM profile 208. The baseband wireless circuitry 110 interacts with the MNO SM-DP+ server 506, at 648, to download the eSIM profile 208, and provides, at 650, a message indicating a successful download of the eSIM profile 208 to the wireless device monitor mode process. The wireless device monitor mode process repeatedly polls the MNO SM-DP+ server 506 as a background process to allow for recovering from error conditions, such as a loss of connection or a failed download of the eSIM profile 208. In some embodiments, the wireless device monitor mode process ends when i) the eSIM profile 208 has been successfully downloaded to and installed on the eUICC 108 of the wireless device 102, or ii) when a threshold number of download retries have occurred. In some embodiments, the wireless device monitor mode process is restarted, if not completed, after a software fault (e.g., operating system crash, communications processing system crash, etc.) or after a hardware shutdown (e.g., initiated by a user) to allow for re-attempting to download the pending eSIM profile 208.

FIG. 6C illustrates a flowchart 660 of an exemplary eSIM provisioning monitor mode method implemented at a wireless device 102 for provisioning and installing an eSIM 208 on an eUICC 108 of a wireless device 102. At 662, the wireless device 102 receives, from an MNO entitlement server 502, an eSIM installation response that includes a unique identifier, e.g., an ICCID value, for the eSIM profile 208 to be installed and (in some embodiments) a pending state indicating whether the eSIM profile 208 is available for downloading at that time or requires the wireless device 102 to wait for a period of time. When the eSIM profile 208 is not available at that time, the wireless device 102, at 664, initiates the eSIM provisioning monitor process. At 666, the wireless directly polls a provisioning server 116, e.g., an MNO SM-DP+ server 506, or indirectly queries, by polling a manufacturer discovery server 508, whether the provisioning server 116 has released the eSIM profile 208 for downloading to the wireless device 102. When the eSIM profile 208 has not been released, the wireless device 102 can perform two actions in parallel: i) at 668, wait for a push notification from a manufacturer notification server 510, and ii) at 676, wait for a back-off time period. After the back-off time period has elapsed, e.g., based on expiration of a back-off timer, and/or after receiving a push notification from the manufacturer notification server 510, the wireless device 102 attempts to download and install the eSIM profile 208 from the provisioning server 116. At 672, the wireless device 102 determines whether the eSIM profile 208 has been successfully installed on the eUICC 108 of the wireless device 102. When the eSIM profile 208 has been successfully installed, the wireless device 102 exits the eSIM provisioning monitor mode, at 674, with a success status indication. When the eSIM profile 208 was not successfully installed, the wireless device 102, at 680, determines whether there are additional back-off time periods available, e.g., the number of back-off timer expirations has not satisfied a threshold number of back-off times. When there are no back-off time periods remaining, the wireless device 102, at 682, exits the eSIM provisioning monitor mode with a failure status indication. When there are additional back-off time periods available, the wireless device 102, returns to wait an additional back-off time period, at 676, before re-attempting to fetch and install the eSIM profile 208. In some embodiments, waiting for back-off timer expirations and waiting for manufacturer push notifications proceed in parallel, and when either occurs, the wireless device 102 can send a query to obtain a status of the eSIM profile 208 availability for download or directly attempt to download the eSIM profile 208. A push notification from the manufacturer notification server 510 can arrive before expiration of the back-off timer and can supersede waiting the remainder of the back-off time period, as the push notification can indicate current availability of the eSIM profile 208 for downloading to the wireless device 102.

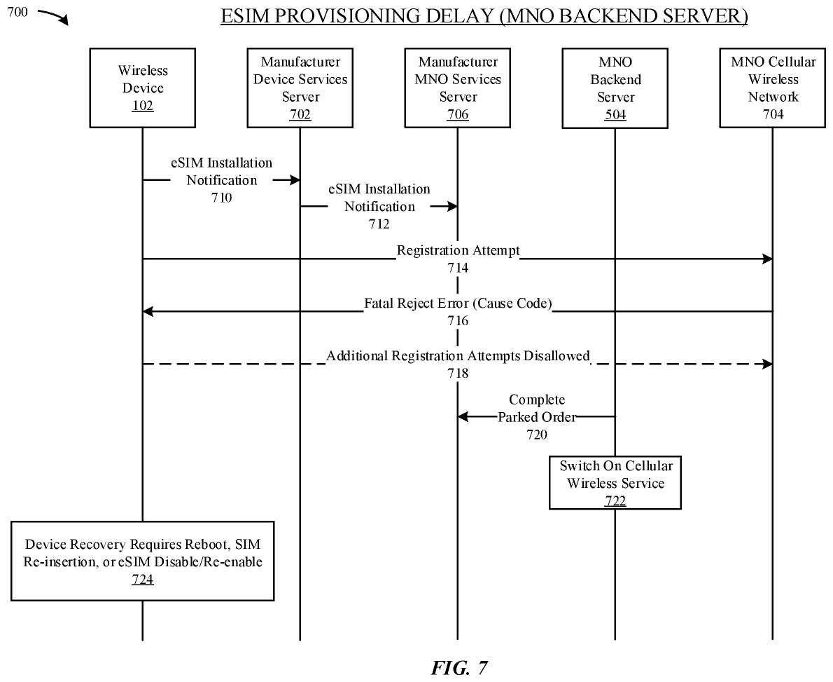

FIG. 7 illustrates a diagram 700 of an example of an eSIM provisioning delay within an MNO's cellular wireless network, e.g., an MNO backend server 504, such as a home subscriber server, has not completed setting up the cellular wireless service subscription associated with the eSIM profile 208 even though the eSIM profile 208 has been made available by the MNO provisioning server 116 to the wireless device 102 to download, install, and enable on an eUICC 108 of the wireless device 102. At 710, the wireless device 102 sends a notification message to a manufacturer-managed devices services server 702 indicating that the eSIM profile 208 was successfully installed. At 712, the manufacturer-managed devices services server 702 forwards the eSIM installation notification message to a manufacturer-managed MNO services server 706. At 714, the wireless device 102 attempts to connect with an access potion of an MNO cellular wireless network 704 and register for access to cellular wireless services of the MNO 114 associated with the eSIM profile 208. When eSIM provisioning for the eSIM profile 208 within the MNO cellular wireless network 704 has not completed, the MNO cellular wireless network 704, at 716, disallows the wireless device 102 a connection and sends an authentication reject message that includes a fatal reject error cause code. In conformance with 3GPP wireless communication standards, additional registration attempts, at 718, by the wireless device 102 as a result of the fatal reject error cause code. Subsequently, the MNO backend server completes the eSIM provisioning and sends, at 720, a complete parked order message to the manufacturer-managed MNO services server 706. At 722, the MNO backend server switches on cellular wireless service for the wireless device 102. Unfortunately, the wireless device 102 has already attempted to connect to the MNO cellular wireless network 704, and the wireless device 102 can re-attempt to connect only after certain conditions are satisfied, e.g., at 724, a device reboot occurs or the eSIM profile 208 is disabled and subsequently re-enabled. (For a physical SIM card, re-attempts are allowed after removing and re-inserting the physical SIM card into the wireless device 102.) In some embodiments, the wireless device 102 periodically disables and re-enables the eSIM profile 208 until successful attachment to and registration with the MNO cellular wireless network 704 occurs.

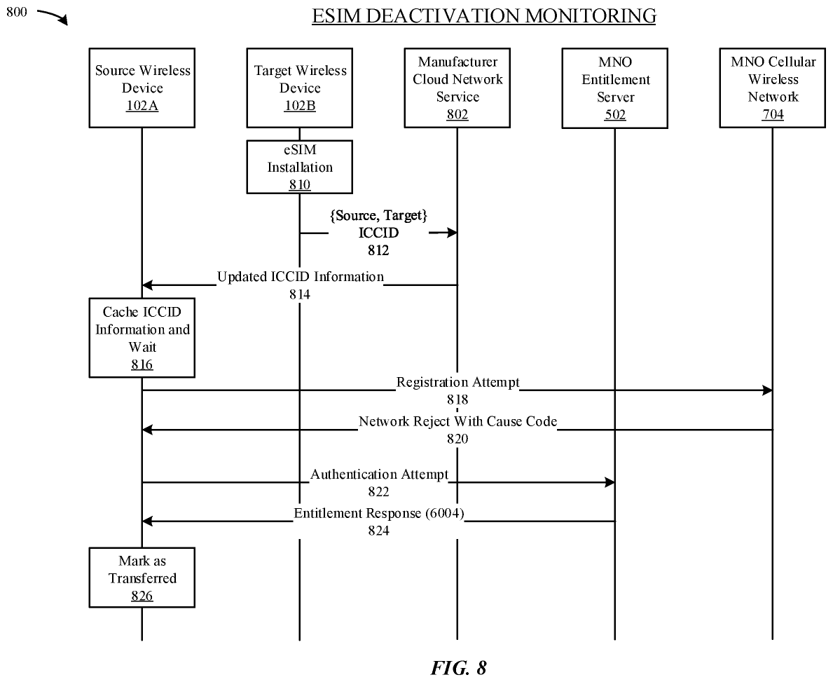

FIG. 8 illustrates a diagram 800 of an exemplary eSIM deactivation monitoring procedure that a source wireless device 102A can use to determine when transfer of cellular wireless service plan associated with an eSIM profile 208 on the source wireless device 102A has transferred successfully to a new eSIM profile 208 downloaded to a target wireless device 102B. The source wireless device 102A can implement an eSIM deactivation monitor mode to determine when the eSIM profile 208 on the source wireless device 102A is no longer active and/or when the new eSIM profile 208 on the target wireless device 102B is active. At 810, the target wireless device 102B installs the new eSIM profile 208. At 812, the target wireless device 102B provides to a manufacturer cloud network service 802 a message that includes identifiers for the source wireless device 102A and the target wireless device 102B and a unique identifier value, e.g., an integrated circuit card identifier (ICCID) value, for the new eSIM profile 208 installed on the target wireless device 102B. At 814, the source wireless device 102A can receive from the target wireless device 102B, via the manufacturer cloud network service 802, to which both the source wireless device 102A and the target wireless device 102B belong, a message that includes the unique identifier value, e.g., ICCID value, for the new eSIM profile 208 installed on the target wireless device 102B. At 816, the source wireless device 102A can cache the ICCID value and wait an amount of time to allow for the new eSIM profile 208 installed on the target wireless device 102B to be activated. The source wireless device 102A can subsequently determine whether the new eSIM profile 208 is activated on the target wireless device 102B, and therefore determine the eSIM profile 208 on the source wireless device 102A is no longer active, by attempting to register with an MNO cellular wireless network 704 using data from the eSIM profile 208 on the source wireless device 102A and/or by attempting to authenticate with an MNO entitlement server 502 using data from the eSIM profile 208 on the source wireless device 102A. At 818, the source wireless device 102A can attempt to authenticate with and attach to the MNO cellular wireless network 704 using credentials of the old eSIM profile 208 on the source wireless device 102A. At 820, the source wireless device 102A can determine that the old eSIM profile 208 is inactive after receiving a network attach reject message, which can include a cause code, from the MNO's cellular wireless network 704. Additionally and/or alternatively, the source wireless device 102A, at 822, attempts to authenticate with the MNO entitlement server 502 using data from the old eSIM profile 208 on the source wireless device 102A and can determine that the old eSIM profile 208 is inactive after receiving a message from the MNO entitlement server 502, at 824, indicating an authentication failure, e.g., an entitlement response message that includes a ‘6004’ code. The source wireless device 102A, at 826, can then mark the old eSIM profile 208 as transferred and inactivated on the source wireless device 102A, e.g., in a user-accessible cellular settings.

In addition to an eSIM provisioning monitor mode, the wireless device 102 can implement an eSIM activation monitor mode to determine when a newly installed and activated eSIM profile 208, a re-activated eSIM profile 208, and/or a replenished data eSIM profile 208 can be used to access services provided by a cellular wireless network of an MNO 114 associated with the eSIM profile 208. Different network conditions can be monitored as part of the eSIM activation monitor mode, including non-access stratum (NAS) network attach responses, entitlement server account query responses, and Internet data connectivity test responses. Each MNO 114 has their own eSIM provisioning systems and procedures and therefore no single eSIM activation monitor mode can be used for all MNOs 114. The wireless device 102 on which an eSIM profile 208 has been downloaded, installed, and enabled can use one or more applicable eSIM activation monitor modes to determine when the eSIM profile 208 is ready to be used with the MNO 114 associated with the eSIM profile 208.

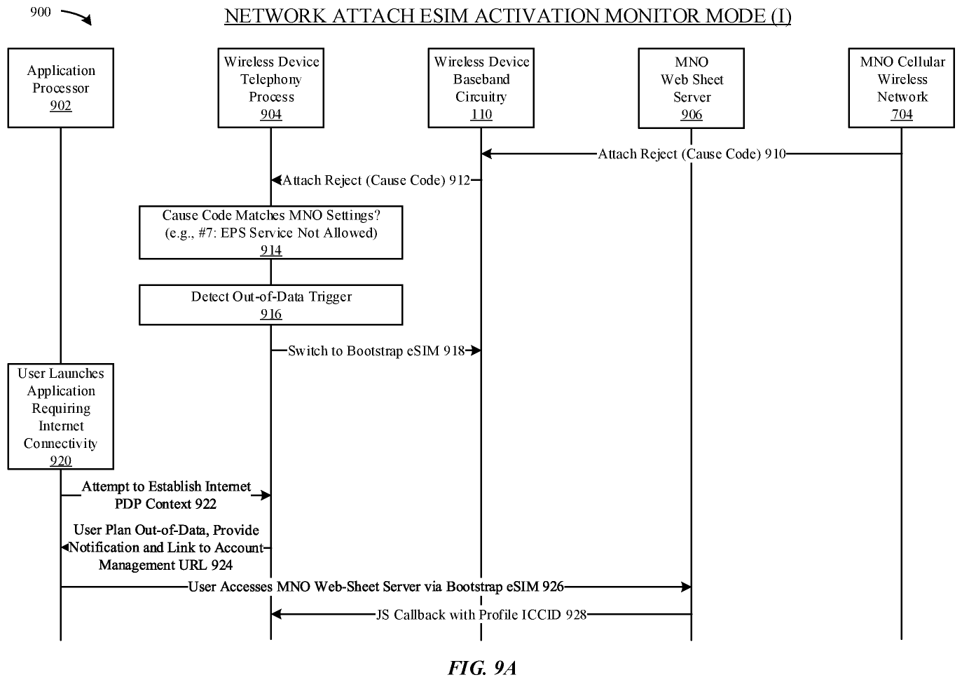

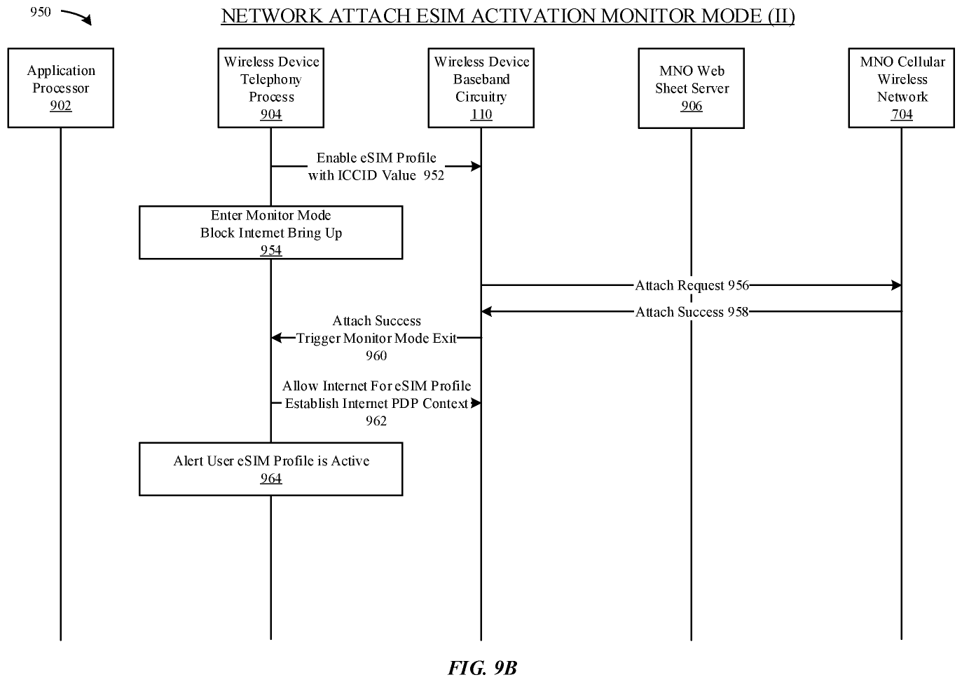

FIGS. 9A and 9B illustrate diagrams 900, 950 of an exemplary network attach eSIM activation monitor mode that a wireless device 102 can implement to determine when activation of an eSIM profile 208 has completed (and therefore the eSIM profile 208 can be used to cellular wireless services). In the specific example shown in FIGS. 9A and 9B, a wireless device 102 refreshes an eSIM profile 208 by interacting with an MNO web sheet server 906 and subsequently determines when the refreshed eSIM profile 208 can be used to access cellular wireless services of the MNO 114 associated with the refreshed eSIM profile 208. The same monitoring described can be used for detecting activation of a newly installed eSIM profile 208. At 910, the baseband wireless circuitry 110 receives from the MNO cellular wireless network 704 an attach reject message with a cause code in response to attempting to attach to the MNO cellular wireless network 704. At 912, the baseband wireless circuitry 110 forwards the attach reject message with the cause code to a telephony process 904 executing on a processor of the wireless device 102. At 914, the telephony process 904 evaluates the cause code from the attach reject message to determine whether the particular cause code (e.g., #7: EPS Service Not Allowed) matches to pre-configured MNO-specific settings, such as available in a pre-loaded configuration file that includes properties for different MNOs 114. At 916, the telephony process 904 detects an out-of-data trigger, e.g., based on the attach reject cause code, which can indicate an allocation for the eSIM profile 208 is depleted. At 918, the telephony process 904 sends a message to the baseband wireless circuitry 110 to switch to using a limited functionality, bootstrap eSIM profile 208, which will allow communication to particular network endpoints to allow for replenishing the depleted eSIM profile 208. At 920, a user of the wireless device 102 launches an application to execute on the application processor 902, the application requiring Internet data connectivity. The application processor 902, at 922, sends a message to the telephony process 904 to establish an Internet PDP context for the application. At 924, the telephony process 904 responds to the application processor 902 with an indication that a user's data plan is out-of-data (and therefore cellular data connectivity via the depleted eSIM profile 208 is unavailable). The telephony process 904 can provide a notification, e.g., a pop-up window, to the user with a link to a network address, e.g., a URL value, to which the user can connect (via the bootstrap eSIM profile 208) to perform account management for the cellular wireless account. At 926, the user of the wireless device 102 accesses an MNO web sheet server 906 using the bootstrap eSIM profile 208. Following required user interaction, the MNO web sheet server 906, at 928, sends to the wireless device 102 a JavaScript (JS) callback message that includes an ICCID value of the eSIM profile that has been replenished. At 952, the telephony process 904 sends a message to the baseband wireless circuitry 110 to re-enable the eSIM profile 208 associated with the received ICCID value. (In some cases, the user obtains a new eSIM profile 208, which is downloaded and installed on the eUICC 108 of the wireless device 102, and the JS callback message includes the ICCID value of the new eSIM profile to be used). At 954, the telephony process 904 initiates a network attach eSIM activation monitor mode to determine when the replenished (or newly installed) eSIM profile 208 can be used. At 954, the telephony process 904 also blocks Internet PDP context establishment until learning that the eSIM profile 208 can be successfully used. At 956, the baseband wireless circuitry 110 sends an attach request message to the MNO cellular wireless network 704 to attempt to attach to an access portion of the MNO cellular wireless network 704 (and subsequently register service with the MNO cellular wireless network 704). At 958, the baseband wireless circuitry 110 receives an attach success message in response to the attach request. The baseband wireless circuitry 110, at 960, forwards an indication of the attach success to the telephony process 904 to trigger exiting the network attach eSIM activation monitor mode. At 962, the telephony process sends a message to the baseband wireless circuitry 110 to allow Internet connectivity for the eSIM profile 208 and establish an Internet PDP context with the MNO cellular wireless network. At 964, the telephony process alerts the user of the wireless device 102 that the replenished (or newly installed) eSIM profile is active. In some embodiments, the telephony process changes a status of the eSIM profile in a cellular settings to “active” (which can also be referred to as “on” or “activated”) without interrupting the user with a pop-up notification message. Waiting for an attach request success after a previous attach reject for an eSIM profile 208 can be a preferred eSIM activation monitor mode to use for particular MNOs 114.

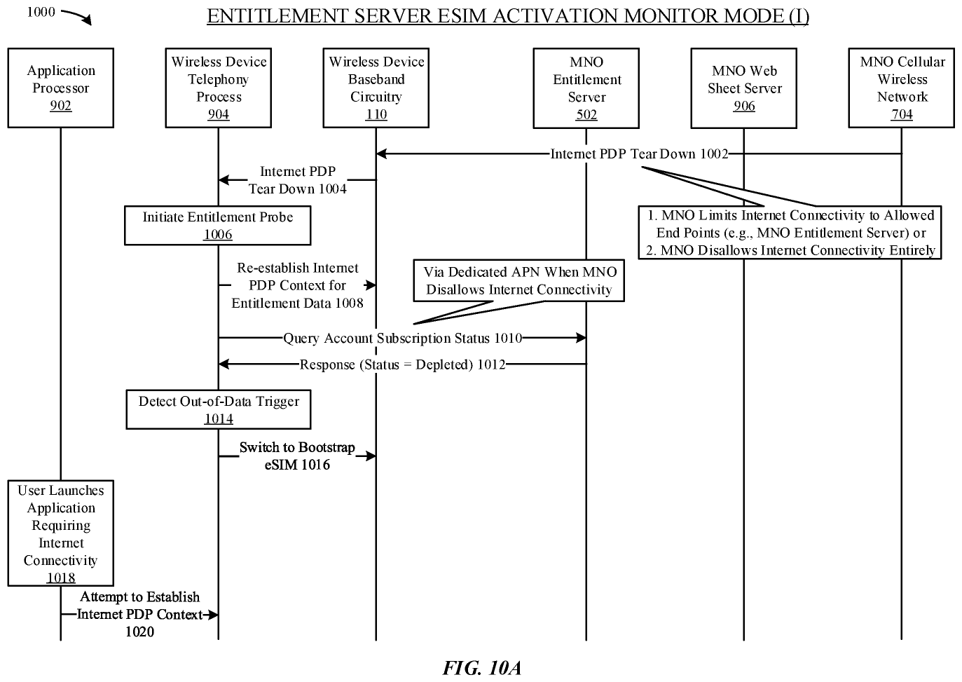

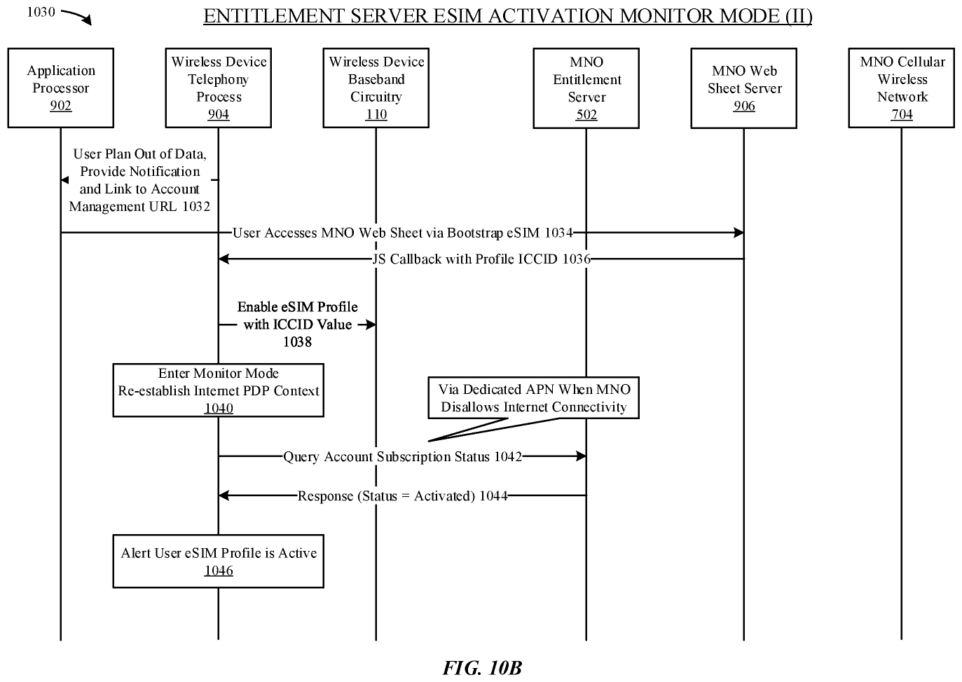

FIGS. 10A and 10B illustrate diagrams 1000, 1030 of an exemplary entitlement server eSIM activation monitor mode that a wireless device 102 can implement to determine when activation of an eSIM profile 208 has completed (and therefore the eSIM profile 208 can be used to cellular wireless services). In the specific example shown in FIGS. 10A and 10B, a wireless device 102 replenishes a depleted eSIM profile 208 by interacting with an MNO web sheet server 906 and subsequently determines when the replenished eSIM profile 208 can be used to access cellular wireless services of the MNO 114 associated with the replenished eSIM profile 208. The same monitoring described can be used for detecting activation of a newly installed eSIM profile 208. At 1002, the MNO cellular wireless network 704 sends a message to the baseband wireless circuitry 110 tearing down an existing Internet PDP context for a data connection using an eSIM profile 208. The MNO cellular wireless network 704 can close the Internet data connection because a data allocation for the eSIM profile 208 has been depleted. In some cases, the MNO cellular wireless network 704 will allow limited Internet connectivity by the wireless device 102 using the eSIM profile 208, e.g., to an MNO web sheet server 906, even though the eSIM profile 208 is not allowed to be used for general Internet data access. In some cases, the MNO cellular wireless network 704 disallows Internet connectivity entirely (in which case the wireless device 102 can revert to using a limited functionality, bootstrap provisioning eSIM profile 208 until the deleted eSIM profile 208 is replenished). At 1004, the baseband wireless circuitry 110 notifies a telephony process 904, which can be executing on a processor separate from the baseband wireless circuitry 110, of the Internet PDP context tear down. At 1006, the telephony process 904 initiates an entitlement server probe to determine a cause for the Internet PDP context tear down. At 1008, the telephony process 904 requests the baseband wireless circuitry 110 re-establish an Internet PDP context specifically to obtain information from the MNO entitlement server 502. In some cases, the depleted eSIM profile 208 can be used to communicate with the MNO entitlement server 502. In some cases, the MNO entitlement server 502 can be reach via a dedicated access point name (APN) when the MNO 114 disallows Internet connectivity via the depleted eSIM profile 208. At 1010, the telephony process 904 sends a query to the MNO entitlement server 502 requesting status of a cellular wireless subscription account associated with the eSIM profile 208. At 1012, the MNO entitlement server 502 responds with a message indicating that the eSIM profile 208 has depleted its allocation. At 1014, the telephony process 904 detects an out-of-data condition (based on the MNO entitlement server's response), and at 1016, the telephony process sends a message to the baseband wireless circuitry 110 to switch to using a limited functionality, bootstrap provisioning eSIM profile 208. At 1018, a user of the wireless device 102 launches an application to execute on the application processor 902, the application requiring Internet data connectivity. The application processor 902, at 1020, sends a message to the telephony process 904 to establish an Internet PDP context for the application. At 1032, the telephony process 904 responds to the application processor 902 with an indication that a user's data plan is out-of-data (and therefore cellular data connectivity via the depleted eSIM profile 208 is unavailable). The telephony process 904 can provide a notification, e.g., a pop-up window, to the user with a link to a network address, e.g., a URL value, to which the user can connect (via the bootstrap eSIM profile 208) to perform account management for the cellular wireless account. At 1034, the user of the wireless device 102 accesses an MNO web sheet server 906 using the bootstrap eSIM profile 208. Following required user interaction, the MNO web sheet server 906, at 1036, sends to the wireless device 102 a JavaScript (JS) callback message that includes an ICCID value of the eSIM profile that has been replenished. At 1038, the telephony process 904 sends a message to the baseband wireless circuitry 110 to re-enable the eSIM profile 208 associated with the received ICCID value. (In some cases, the user obtains a new eSIM profile 208, which is downloaded and installed on the eUICC 108 of the wireless device 102, and the JS callback message includes the ICCID value of the new eSIM profile to be used). At 1040, the telephony process 904 initiates an entitlement server eSIM activation monitor mode to determine when the replenished (or newly installed) eSIM profile 208 can be used. At 1042, the telephony process 904 sends a query to the MNO entitlement server 502 requesting status of a cellular wireless subscription account associated with the eSIM profile 208. In some cases, the depleted eSIM profile 208 can be used to communicate with the MNO entitlement server 502. In some cases, the MNO entitlement server 502 can be reach via a dedicated access point name (APN) when the MNO 114 disallows Internet connectivity via the depleted eSIM profile 208. At 1044, the MNO entitlement server 502 responds with a message indicating that the eSIM profile 208 is activated (which can correspond to replenishment for the previously depleted eSIM profile 208 or to newly completed activation of a newly installed eSIM profile 208). At 1046, the telephony process alerts the user of the wireless device 102 that the replenished (or newly installed) eSIM profile is active. In some embodiments, the telephony process changes a status of the eSIM profile in a cellular settings to “active” (which can also be referred to as “on” or “activated”) without interrupting the user with a pop-up notification message. Querying the MNO entitlement server 502 to determine an active status or inactive status for an eSIM profile 208 can be a preferred eSIM activation (or deactivation) monitor mode to use for particular MNOs 114.

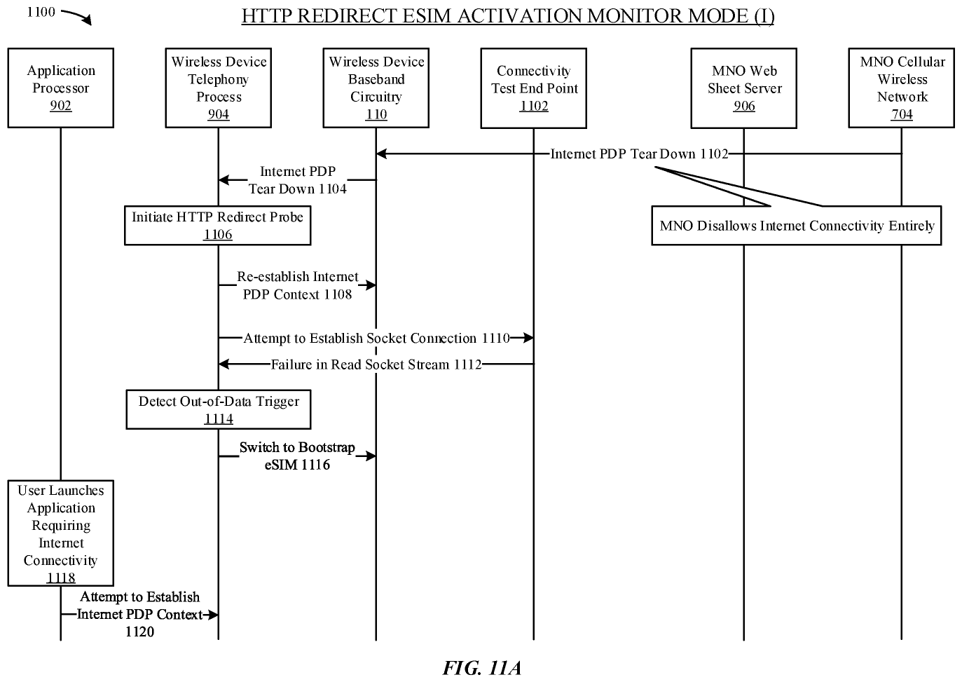

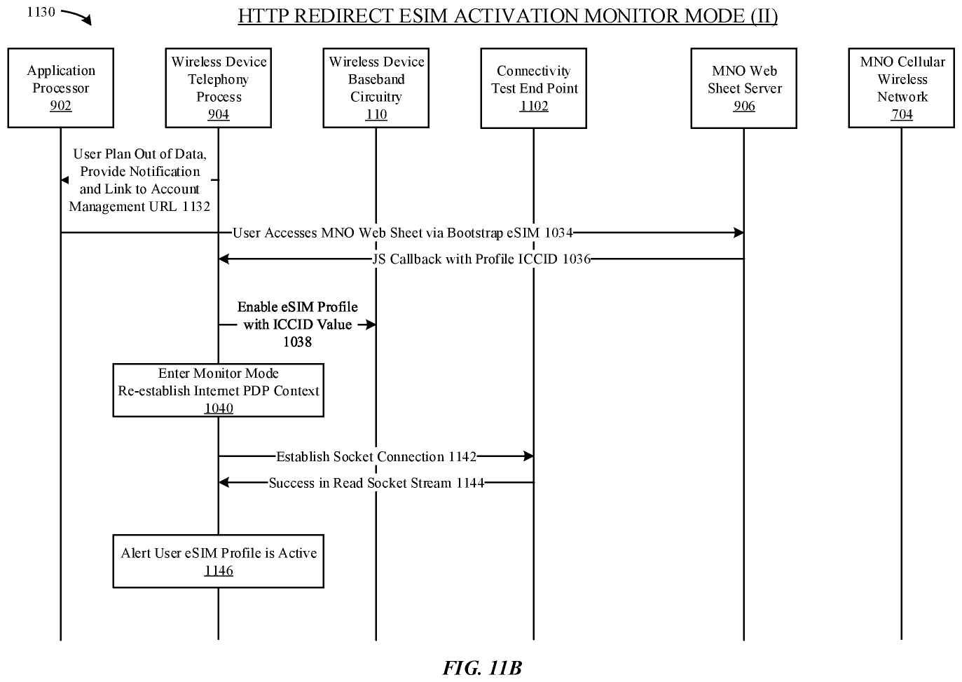

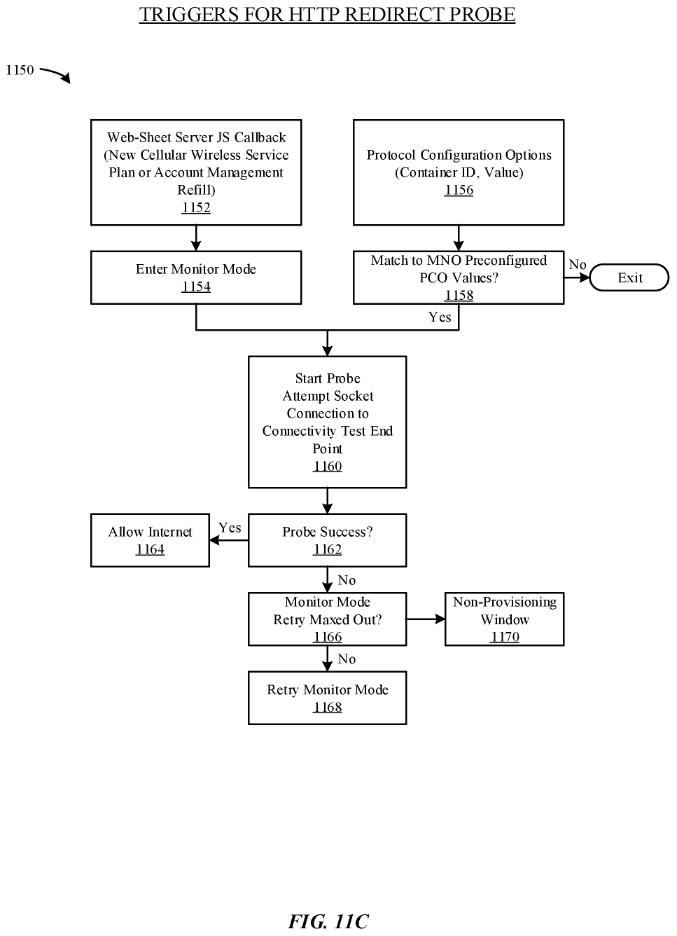

FIGS. 11A and 11B illustrate diagrams 1100, 1130 of an exemplary Hypertext Transfer Protocol (HTTP) redirect eSIM activation monitor mode that a wireless device 102 can implement to determine when activation of an eSIM profile 208 has completed (and therefore the eSIM profile 208 can be used to cellular wireless services). In the specific example shown in FIGS. 11A and 11B, a wireless device 102 replenishes a depleted eSIM profile 208 by interacting with an MNO web sheet server 906 and subsequently determines when the replenished eSIM profile 208 can be used to access cellular wireless services of the MNO 114 associated with the replenished eSIM profile 208. The same monitoring described can be used for detecting activation of a newly installed eSIM profile 208. At 1102, the MNO cellular wireless network 704 sends a message to the baseband wireless circuitry 110 tearing down an existing Internet PDP context for a data connection using an eSIM profile 208. The MNO cellular wireless network 704 can close the Internet data connection because a data allocation for the eSIM profile 208 has been depleted. In some cases, the MNO cellular wireless network 704 disallows Internet connectivity entirely (in which case the wireless device 102 can revert to using a limited functionality, bootstrap provisioning eSIM profile 208 until the deleted eSIM profile 208 is replenished). At 1104, the baseband wireless circuitry 110 notifies a telephony process 904, which can be executing on a processor separate from the baseband wireless circuitry 110, of the Internet PDP context tear down. At 1106, the telephony process 904 initiates an HTTP redirect probe to determine a cause for the Internet PDP context tear down. At 1108, the telephony process 904 requests the baseband wireless circuitry 110 re-establish an Internet PDP context specifically to allow testing to a specific test end point. At 1110, the telephony process 904 attempts to establish a data socket connection to a pre-determined connectivity test end point 1102. At 1112, the telephony process 904 detects a failure to read a data socket stream from the connectivity test end point 1102. At 1114, as a result of the read failure, the telephony process 904 detects an out-of-data trigger condition. At 1116, the telephony process 904 the telephony process sends a message to the baseband wireless circuitry 110 to switch to using a limited functionality, bootstrap provisioning eSIM profile 208. At 1118, a user of the wireless device 102 launches an application to execute on the application processor 902, the application requiring Internet data connectivity. The application processor 902, at 1120, sends a message to the telephony process 904 to establish an Internet PDP context for the application. At 1132, the telephony process 904 responds to the application processor 902 with an indication that a user's data plan is out-of-data (and therefore cellular data connectivity via the depleted eSIM profile 208 is unavailable). The telephony process 904 can provide a notification, e.g., a pop-up window, to the user with a link to a network address, e.g., a URL value, to which the user can connect (via the bootstrap eSIM profile 208) to perform account management for the cellular wireless account. At 1134, the user of the wireless device 102 accesses an MNO web sheet server 906 using the bootstrap eSIM profile 208. Following required user interaction, the MNO web sheet server 906, at 1136, sends to the wireless device 102 a JavaScript (JS) callback message that includes an ICCID value of the eSIM profile that has been replenished. At 1138, the telephony process 904 sends a message to the baseband wireless circuitry 110 to re-enable the eSIM profile 208 associated with the received ICCID value. (In some cases, the user obtains a new eSIM profile 208, which is downloaded and installed on the eUICC 108 of the wireless device 102, and the JS callback message includes the ICCID value of the new eSIM profile to be used). At 1040, the telephony process 904 starts an HTTP redirect eSIM activation monitor mode to determine when the replenished (or newly installed) eSIM profile 208 can be used, and re-establishes an Internet PDP context to communicate with the connectivity test end point 1102. At 1142, the telephony process 904 establishes a data socket connection to a pre-determined connectivity test end point 1102 using the re-enabled (or newly installed and enabled) eSIM profile 208. At 1144, the telephony process 904 detects successfully reads a data socket stream from the connectivity test end point 1102. At 1146, the telephony process alerts the user of the wireless device 102 that the replenished (or newly installed) eSIM profile is active. In some embodiments, the telephony process changes a status of the eSIM profile in a cellular settings to “active” (which can also be referred to as “on” or “activated”) without interrupting the user with a pop-up notification message. Testing an ability to receive read via a data socket connection to a connectivity test end point 1102 allowing the wireless device 102 to determine an active status or inactive status for an eSIM profile 208 can be a preferred eSIM activation (or deactivation) monitor mode to use for particular MNOs 114.

FIG. 11C illustrates a flowchart 1150 of exemplary triggers to cause a wireless device to perform an HTTP redirect probe to detect activation of an eSIM profile 208. The wireless device 102 can enter an HTTP redirect eSIM activation monitor mode, at 1154, to determine when a newly installed, replenished, and/or re-enabled eSIM profile 208 is ready to be used with an MNO cellular wireless network 704, i.e., when the MNO cellular wireless network 704 will allow connections based on credentials of the eSIM profile 208. Receipt of a JavaScript callback, at 1152, from an MNO web sheet server 906, can occur after installation of a new SIM profile 208 associated with a new cellular wireless service plan or after replenishment of an existing SIM profile 208 that has an MNO-prescribed allocation, e.g., a data plan with a particular limit, and trigger entering the HTTP redirect eSIM activation monitor mode (such as illustrated previously in FIGS. 11A and 11B). Alternatively, in some embodiments, an MNO 114 sends to the wireless device 102, via an MNO entitlement server 502, a message that includes protocol configuration options (PCO) with a container identifier (ID) and one or more values specifying (or causing) an action (or actions) to be performed by the wireless device 102. The wireless device 102 can maintain a database of expected sets of PCO values for different MNOs 114 and can determine, at 1158, whether a message from the MNO entitlement server 502 matches pre-configured PCO values for the MNO 114 to perform an HTTP redirect probe. When the message from the MNO entitlement server 502 does not match the pre-configured PCO values for the MNO 114 to use perform an HTTP redirect probe, the process can exit. When the message from the MNO entitlement server 502 does match the pre-configured PCO values for the MNO 114 to use the HTTP redirect probe (or after entering the HTTP redirect eSIM activation monitor mode at 1154), the wireless device 102 initiates the HTTP redirect probe, at 1160, by attempting to establish a socket connection with and read from a connectivity test end point 1102. When the wireless device 102 determines, 1162, a successful read from the connectivity test end point 1102, the wireless device 102, at 1164 can allow Internet data connections to be used with the eSIM profile 208. When the HTTP redirect probe of the connectivity test end point 1102 is not successful at 1162, the wireless device 102, at 1166, determines whether a threshold number of retries for the HTTP redirect eSIM activation monitor mode is satisfied, e.g., a maximum number of retries have been attempted for the particular HTTP redirect probe monitor mode session, the wireless device 102, 1170, can exit the monitor mode and provide an indication that activation of the eSIM profile 208 by the MNO cellular wireless network has not yet occurred. In some embodiments, the wireless device 102 maintains an indication of “activating” or “inactive” for the eSIM profile 208. In some embodiments, the wireless device 102 provides a notification regarding the delayed (and/or unsuccessful) completion of activation of the eSIM profile 208. When the threshold number of retries has not been satisfied, the wireless device 102, at 1168, can continue in the HTTP redirect eSIM activation monitor mode and retry the HTTP redirect probe until retries have maxed out or a successful HTTP probe occurs.

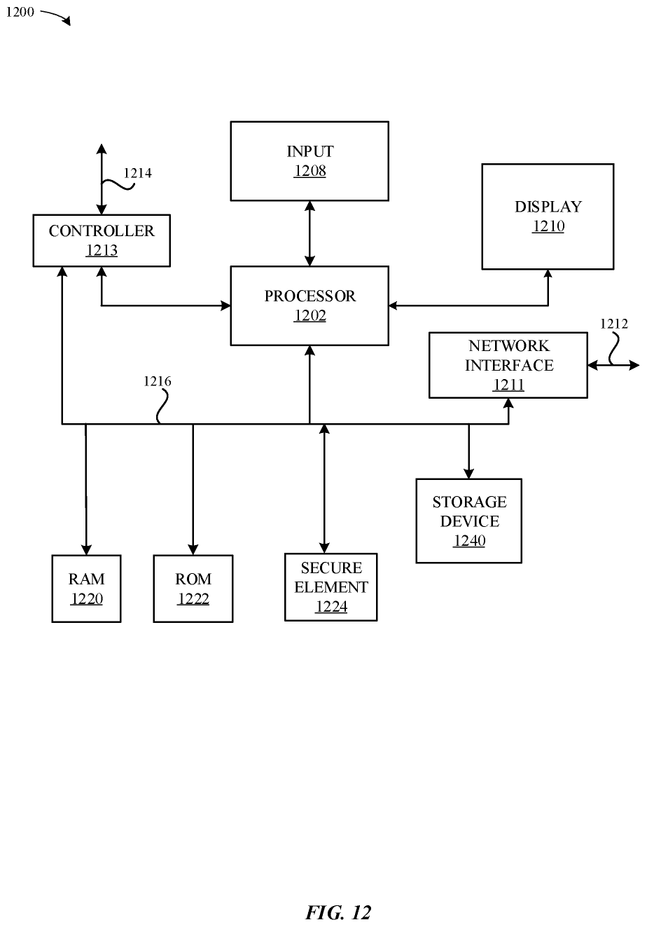

FIG. 12 illustrates a detailed view of a representative computing device 1200 that can be used to implement various methods described herein, according to some embodiments. In particular, the detailed view illustrates various components that can be included in a wireless device 102. As shown in FIG. 12, the computing device 1200 can include a processor 1202 that represents a microprocessor or controller for controlling the overall operation of computing device 1200. The computing device 1200 can also include a user input device 1208 that allows a user of the computing device 1200 to interact with the computing device 1200. For example, the user input device 1208 can take a variety of forms, such as a button, keypad, dial, touch screen, audio input interface, visual/image capture input interface, input in the form of sensor data, etc. Still further, the computing device 1200 can include a display 1210 that can be controlled by the processor 1202 to display information to the user. A data bus 1216 can facilitate data transfer between at least a storage device 1240, the processor 1202, and a controller 1213. The controller 1213 can be used to interface with and control different equipment through an equipment control bus 1214. The computing device 1200 can also include a network/bus interface 1211 that communicatively couples to a data link 1212. In the case of a wireless connection, the network/bus interface 1211 can include a wireless transceiver.

### Representative Methods

In an exemplary method, a wireless device 102 monitors delayed eSIM 208 provisioning by at least: i) receiving, from an MNO entitlement server 502, an eSIM installation response including a unique identifier associated with an eSIM 208 assigned to the wireless device 102; ii) entering an eSIM installation monitor mode when the eSIM 208 is not available for downloading to the eUICC 108 of the wireless device 102; and iii) while in the eSIM installation monitoring mode: attempting to download and install the eSIM 208 from an MNO provisioning server 116 each time a server polling criterion is satisfied, and exiting the eSIM installation monitor mode when an exit criterion is satisfied, where the server polling criterion is satisfied based on expiration of a back-off timer, and the exit criterion is satisfied when the eSIM 208 is installed or a threshold number of back-off retries is satisfied.

In some embodiments, the server polling criterion is further satisfied based on receipt of a push notification message from a manufacturer-managed, network-based server 510, the push notification message indicating the eSIM 208 is available to download to the wireless device 102. In some embodiments, the method further includes the wireless device 102 downloading and installing the eSIM 208 from the MNO provisioning server 116 when the eSIM installation response indicates the eSIM 208 is available for download. In some embodiments, the method further includes the wireless device 102 restarting the eSIM installation monitor mode to download the eSIM 208 after interruption by a software failure before installation of the eSIM 208 occurs. In some embodiments, the method further includes the wireless device 102 displaying an error notification message directing a user to contact the MNO 114 associated with the eSIM 208 when the threshold number of back-off retries is satisfied before the eSIM 208 is installed. In some embodiments, the method further includes the wireless device 102 updating a status of the eSIM 208 to indicate activating while the eSIM installation monitor mode is running and to indicate on or active when eSIM installation and activation completes successfully. In some embodiments, the unique identifier associated with the eSIM includes an ICCID value. In some embodiments, the eSIM installation response includes an indication that the eSIM 208 assigned to the wireless device 102 is pending release and unavailable for download.

In another exemplary method, a source wireless device 102A monitors for deactivation of an eSIM 208 by at least: i) receiving, via a cloud network service 802, a transfer notification indicating successful transfer of a cellular wireless service plan associated with an eSIM 208 associated with an MNO 114 from the source wireless device 102A to a target wireless device 102B; and ii) updating a user-readable cellular settings status of the eSIM 208 to indicate transferal of the eSIM 208 based on failure to authenticate or register with a cellular wireless network of the MNO 114 using the eSIM 208. In some embodiments, the method further includes the source wireless device 102A: i) attempting to register with the cellular wireless network 704 of the MNO 114 using the eSIM 208, and ii) updating the user-readable cellular settings status of the eSIM 208 to indicate the transferal of the eSIM 208 in response to receipt of an attach reject message from the cellular wireless network 704 of the MNO 114. In some embodiments, the method further includes the source wireless device 102A: i) attempting to authenticate with the cellular wireless network 704 of the MNO 114 using the eSIM 208, and ii) updating the user-readable cellular settings status of the eSIM 208 to indicate the transferal of the eSIM 208 in response to receipt of an authentication failure message from an entitlement server 502 of the MNO 114. In some embodiments, the transfer notification includes an ICCID value of a new eSIM 208 associated with the transferred cellular wireless service plan and installed at the target wireless device 102B.

In a further exemplary method, a wireless device 102 monitors for activation of an eSIM profile 208 installed in the wireless device 102 by at least: i) marking the eSIM profile 208 in a user-accessible cellular settings as activating or inactive; ii) initiating an eSIM activation monitoring mode after enabling the eSIM profile 208; and iii) while in the eSIM activation monitoring mode: determining whether one or more eSIM activation criteria for the MNO 114 associated with the eSIM profile 208 are satisfied, after the one or more eSIM activation criteria for the MNO114 associated with the eSIM profile 208 are satisfied: exiting the eSIM activation monitoring mode, and updating the eSIM profile 208 in the user-accessible cellular settings as active.

In some embodiments, the one or more eSIM activation criteria for the MNO 114 are satisfied when the wireless device 102 successfully attaches to a cellular wireless network 704 of the MNO 114 using the eSIM profile 208. In some embodiments, the one or more eSIM activation criteria for the MNO 114 are satisfied when the wireless device 102 receives an attach success message in response to an attach request message sent to a cellular wireless network 704 of the MNO 114 using the eSIM profile 208. In some embodiments, the one or more eSIM activation criteria for the MNO 114 are satisfied when the wireless device 102 receives a response message from an MNO entitlement server 502 indicating an activated status for a cellular wireless service subscription account. In some embodiments, the one or more eSIM activation criterion for the MNO 114 are satisfied when the wireless device 102 successfully reads data via a socket connection to a connectivity test end point 1102 using the eSIM profile 208. In some embodiments, the method further includes the wireless device 102: i) blocking Internet data connection establishment via the eSIM profile 208 while in the eSIM activation monitoring mode; and ii) allowing Internet data connection establishment via the eSIM profile 208 after exiting the eSIM activation monitoring mode. In some embodiments, the eSIM profile 208 includes a data-only eSIM 208, and the method further includes the wireless device 102: i) detecting an out-of-data trigger for the eSIM profile 208; ii) disabling the eSIM profile 208 and marking the eSIM profile 208 as inactive; and iii) enabling the eSIM profile 208 based on receiving, from an MNO web sheet server 906, a message indicating the eSIM profile 208 is active. In some embodiments, the method further includes the wireless device 102: i) enabling a limited functionality provisioning eSIM 208 after disabling the eSIM profile 208; and ii) communicating with the MNO web sheet server 906 via the limited functionality provisioning eSIM 208. In some embodiments, detecting the out-of-data trigger for the eSIM profile 208 includes receiving, from a cellular wireless network 704 of the MNO 114 associated with the eSIM profile 208, an attach reject message indicating data access is disallowed. In some embodiments, detecting the out-of-data trigger for the eSIM profile 208 includes receiving, from an entitlement server 502 of the MNO 114 associated with the eSIM profile 208, a subscription status message indicating a depleted data allocation. In some embodiments, detecting the out-of-data trigger for the eSIM profile 208 includes detecting failure to read data via a socket connection to a connectivity test end point 1102 using the eSIM profile 208.

In another exemplary method, a wireless device 102 performs eSIM profile status management by at least: i) enabling a limited functionality provisioning eSIM 208 after detecting an out-of-data trigger for the wireless device 102; ii) responsive to a requirement for data connectivity for an application executing on the wireless device 102, providing a notification indicating a requirement for cellular wireless service account management; iii) accessing a MNO web sheet server 906, via a connection using the limited functionality provisioning eSIM 208, to manage cellular wireless service for an eSIM profile 208; iv) receiving, from the MNO web sheet server 906, a callback message indicating replenishment of a data plan associated with the eSIM profile 208; v) enabling the eSIM profile 208; and vi) updating user-accessible cellular settings to indicate the eSIM profile 208 is active after detecting successful use of the eSIM profile 208 following enablement.

In some embodiments, i) detecting the out-of-data trigger for the eSIM profile 208 includes receiving, from a cellular wireless network 704 of the MNO 114 associated with the eSIM profile 208, an attach reject message indicating data access is disallowed; and ii) detecting successful use of the eSIM profile 208 following enablement includes successfully attaching to a cellular wireless network 704 of the MNO 114 using the eSIM profile 208 after enablement of the eSIM profile 208. In some embodiments, i) detecting the out-of-data trigger for the eSIM profile 208 includes receiving, from an entitlement server 502 of the MNO 114 associated with the eSIM profile 208, a subscription status message indicating a depleted data allocation, and ii) detecting successful use of the eSIM profile 208 following enablement includes receiving a response message from the entitlement server 502 of the MNO 114 indicating an activated status for a cellular wireless service subscription account associated with the eSIM profile 208. In some embodiments, i) detecting the out-of-data trigger for the eSIM profile 208 includes detecting failure to read data via a socket connection to a connectivity test end point 1102 using the eSIM profile 208; and ii) detecting successful use of the eSIM profile 208 following enablement comprises successfully reading data via the socket connection to the connectivity test end point 1102 using the eSIM profile 208.

In an additional exemplary embodiment, a wireless device 102 performs monitoring of eSIM data connectivity monitory for an eSIM profile 208 by at least: i) initiating a data connectivity monitor mode; ii) while in the data connectivity mode: attempting to read data one or more times via a socket connection to a connectivity test end point 1102 using the eSIM profile 208, and exiting the data connectivity monitor mode after successfully reading data via the socket connection or after a data connectivity monitor mode retry threshold is satisfied; and iii) allowing Internet data access via the eSIM profile 208 after successfully reading data via the socket connection.

In some embodiments, the wireless device 102 initiates the data connectivity monitor mode in response to receipt of a callback message from a web sheet server 906 of an MNO 114 associated with the eSIM profile 208, the callback message indicating the eSIM profile 208 is active. In some embodiments, the callback message is associated with activation of a new cellular wireless service plan associated with the eSIM profile 208. In some embodiments, the callback message is associated with an account management refill for a cellular wireless service plan associated with the eSIM profile 208. In some embodiments, the wireless device 102 initiates the data connectivity monitor mode in response to receipt of one or more protocol configuration option (PCO) values that match to settings for the MNO 114 associated with the eSIM profile 208.

### Representative Device

The computing device 1200 also includes a storage device 1240, which can comprise a single disk or a plurality of disks (e.g., hard drives), and includes a storage management module that manages one or more partitions within the storage device 1240. In some embodiments, storage device 1240 can include flash memory, semiconductor (solid state) memory or the like. The computing device 1200 can also include a Random Access Memory (RAM) 1220 and a Read-Only Memory (ROM) 1222. The ROM 1222 can store programs, utilities or processes to be executed in a non-volatile manner. The RAM 1220 can provide volatile data storage, and stores instructions related to the operation of the computing device 1200. The computing device 1200 can further include a secure element (SE) 1224, such as an eUICC 108, a UICC 118, or another secure storage for cellular wireless system access by a wireless device 102.

### Wireless Terminology

In accordance with various embodiments described herein, the terms “wireless communication device,” “wireless device,” “mobile wireless device,” “mobile station,” and “user equipment” (UE) may be used interchangeably herein to describe one or more common consumer electronic devices that may be capable of performing procedures associated with various embodiments of the disclosure. In accordance with various implementations, any one of these consumer electronic devices may relate to: a cellular phone or a smart phone, a tablet computer, a laptop computer, a notebook computer, a personal computer, a netbook computer, a media player device, an electronic book device, a MiFi® device, a wearable computing device, as well as any other type of electronic computing device having wireless communication capability that can include communication via one or more wireless communication protocols such as used for communication on: a wireless wide area network (WWAN), a wireless metro area network (WMAN) a wireless local area network (WLAN), a wireless personal area network (WPAN), a near field communication (NFC), a cellular wireless network, a fourth generation (4G) Long Term Evolution (LTE), LTE Advanced (LTE-A), and/or 5G or other present or future developed advanced cellular wireless networks.

The wireless communication device, in some embodiments, can also operate as part of a wireless communication system, which can include a set of client devices, which can also be referred to as stations, client wireless devices, or client wireless communication devices, interconnected to an access point (AP), e.g., as part of a WLAN, and/or to each other, e.g., as part of a WPAN and/or an “ad hoc” wireless network. In some embodiments, the client device can be any wireless communication device that is capable of communicating via a WLAN technology, e.g., in accordance with a wireless local area network communication protocol. In some embodiments, the WLAN technology can include a Wi-Fi (or more generically a WLAN) wireless communication subsystem or radio, the Wi-Fi radio can implement an Institute of Electrical and Electronics Engineers (IEEE) 802.11 technology, such as one or more of: IEEE 802.11a; IEEE 802.11b; IEEE 802.11g; IEEE 802.11-2007; IEEE 802.11n; IEEE 802.11-2012; IEEE 802.11ac; or other present or future developed IEEE 802.11 technologies.

Additionally, it should be understood that the UEs described herein may be configured as multi-mode wireless communication devices that are also capable of communicating via different third generation (3G) and/or second generation (2G) RATs. In these scenarios, a multi-mode UE can be configured to prefer attachment to LTE networks offering faster data rate throughput, as compared to other 3G legacy networks offering lower data rate throughputs. For instance, in some implementations, a multi-mode UE may be configured to fall back to a 3G legacy network, e.g., an Evolved High Speed Packet Access (HSPA+) network or a Code Division Multiple Access (CDMA) 2000 Evolution-Data Only (EV-DO) network, when LTE and LTE-A networks are otherwise unavailable.

The various aspects, embodiments, implementations or features of the described embodiments can be used separately or in any combination. Various aspects of the described embodiments can be implemented by software, hardware or a combination of hardware and software. The described embodiments can also be embodied as computer readable code on a non-transitory computer readable medium. The non-transitory computer readable medium is any data storage device that can store data which can thereafter be read by a computer system. Examples of the non-transitory computer readable medium include read-only memory, random-access memory, CD-ROMs, HDDs, DVDs, magnetic tape, and optical data storage devices. The non-transitory computer readable medium can also be distributed over network-coupled computer systems so that the computer readable code is stored and executed in a distributed fashion.

Regarding the present disclosure, it is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of specific embodiments are presented for purposes of illustration and description. They are not intended to be exhaustive or to limit the described embodiments to the precise forms disclosed. It will be apparent to one of ordinary skill in the art that many modifications and variations are possible in view of the above teachings.

What is claimed is:

1. A wireless device comprising:
wireless circuitry comprising one or more antennas; and
one or more processors communicatively coupled to the wireless circuitry and to a memory storing instructions that, when executed by the one or more processors, configure the wireless device to:
receive, from a mobile network operator (MNO) entitlement server, an electronic subscriber identity module (eSIM) installation response including a unique identifier associated with an eSIM assigned to the wireless device;
enter an eSIM installation monitor mode when the eSIM is not available for download; and
while in the eSIM installation monitor mode:
attempt to download and install the eSIM from an MNO provisioning server each time a server polling criterion is satisfied; and
exit the eSIM installation monitor mode when an exit criterion is satisfied,
wherein:
the server polling criterion is satisfied based on expiration of a back-off timer, and
the exit criterion is satisfied when the eSIM is installed or a threshold number of back-off retries is satisfied.

2. The wireless device of claim 1, wherein the server polling criterion is further satisfied based on receipt of a push notification message from a manufacturer-managed, network-based server, the push notification message indicating the eSIM is available to download to the wireless device.

3. The wireless device of claim 1, wherein the wireless device is further configured to download and install the eSIM from the MNO provisioning server when the eSIM installation response indicates the eSIM is available for download.

4. The wireless device of claim 1, wherein the wireless device is further configured to restart the eSIM installation monitor mode to download the eSIM after interruption by a software failure before installation of the eSIM occurs.

5. The wireless device of claim 1, wherein the wireless device is further configured to display an error notification message directing a user to contact the MNO associated with the eSIM when the threshold number of back-off retries is satisfied before the eSIM is installed.

6. The wireless device of claim 1, wherein the wireless device is further configured to update a status of the eSIM to indicate activating while the eSIM installation monitor mode is running and to indicate on or active when eSIM installation and activation completes successfully.

7. The wireless device of claim 1, wherein the unique identifier associated with the eSIM comprises an integrated circuit card identifier (ICCID) value.

8. The wireless device of claim 1, wherein the eSIM installation response includes an indication that the eSIM assigned to the wireless device is pending release and unavailable for download.

9. A method for delayed electronic subscriber identity module (eSIM) provisioning monitoring by a wireless device, the method comprising:
by the wireless device:
receiving, from a mobile network operator (MNO) entitlement server, an eSIM installation response including a unique identifier associated with an eSIM assigned to the wireless device;
entering an eSIM installation monitor mode when the eSIM is not available for download; and
while in the eSIM installation monitor mode:
attempting to download and install the eSIM from an MNO provisioning server each time a server polling criterion is satisfied; and
exiting the eSIM installation monitor mode when an exit criterion is satisfied,
wherein:
the server polling criterion is satisfied based on expiration of a back-off timer, and
the exit criterion is satisfied when the eSIM is installed or a threshold number of back-off retries is satisfied.

10. The method of claim 9, wherein the server polling criterion is further satisfied based on receipt of a push notification message from a manufacturer-managed, network-based server, the push notification message indicating the eSIM is available to download to the wireless device.

11. The method of claim 9, wherein the method further comprises:
by the wireless device:
downloading and installing the eSIM from the MNO provisioning server when the eSIM installation response indicates the eSIM is available for download.

12. The method of claim 9, wherein the method further comprises:
by the wireless device:
restarting the eSIM installation monitor mode to download the eSIM after interruption by a software failure before installation of the eSIM occurs.

13. The method of claim 9, wherein the method further comprises:
by the wireless device:
displaying an error notification message directing a user to contact the MNO associated with the eSIM when the threshold number of back-off retries is satisfied before the eSIM is installed.

14. The method of claim 9, wherein the method further comprises:
by the wireless device:
updating a status of the eSIM to indicate:
activating, while the eSIM installation monitor mode is running, and
on or active, when eSIM installation and activation completes successfully.

15. The method of claim 9, wherein the unique identifier associated with the eSIM comprises an integrated circuit card identifier (ICCID) value.

16. The method of claim 9, wherein the eSIM installation response includes an indication that the eSIM assigned to the wireless device is pending release and unavailable for download.

17. A source wireless device comprising:
wireless circuitry comprising one or more antennas; and
one or more processors communicatively coupled to the wireless circuitry and to a memory storing instructions that, when executed by the one or more processors, configure the source wireless device to:
receive, via a cloud network service, a transfer notification indicating successful transfer of a cellular wireless service plan associated with an electronic subscriber identity module (eSIM) associated with a mobile network operator (MNO) from the source wireless device to a target wireless device; and
update a user-readable cellular settings status of the eSIM to indicate transferal of the eSIM based on failure to authenticate or register with a cellular wireless network of the MNO using the eSIM.

18. The source wireless device of claim 17, wherein the source wireless device is further configured to:
attempt to register with the cellular wireless network of the MNO using the eSIM; and
update the user-readable cellular settings status of the eSIM to indicate the transferal of the eSIM in response to receipt of an attach reject message from the cellular wireless network of the MNO.

19. The source wireless device of claim 17, wherein the source wireless device is further configured to:
attempt to authenticate with the cellular wireless network of the MNO using the eSIM; and
update the user-readable cellular settings status of the eSIM to indicate the transferal of the eSIM in response to receipt of an authentication failure message from an entitlement server of the MNO.

20. The source wireless device of claim 17, wherein the transfer notification includes an integrated circuit card identifier (ICCID) value of a new eSIM associated with the transferred cellular wireless service plan and installed at the target wireless device.
